(19) United States
(12) Patent Application Publication
(10) Pub. No.: US 2026/0064238 A1
(43) Pub. Date: Mar. 5, 2026

(54) HEAD-WEARABLE ELECTRONIC DEVICE, METHOD, AND NON-TRANSITORY COMPUTER-READABLE STORAGE MEDIUM FOR TOUCH INPUT IN THREE-DIMENSIONAL SPACE

(71) Applicant: Samsung Electronics Co., Ltd., Suwon-si (KR)

(72) Inventors: Hyojin CHO, Suwon-si (KR); Jinmo KANG, Suwon-si (KR); Sungoh KIM, Suwon-si (KR); Donghyun YEOM, Suwon-si (KR); Boyoung LEE, Suwon-si (KR); Sanghun LEE, Suwon-si (KR)

(21) Appl. No.: 19/281,316

(22) Filed: Jul. 25, 2025

Related U.S. Application Data
(63) Continuation of application No. PCT/KR2025/007823, filed on Jun. 9, 2025.

(30) Foreign Application Priority Data
Aug. 29, 2024 (KR) 10-2024-0117114
Oct. 15, 2024 (KR) 10-2024-0140614

(51) Int. Cl. G06F 3/04815; G06F 3/01; G06T 7/50; G06T 15/20; G06T 19/20

(52) U.S. Cl. CPC G06F 3/04815; G06F 3/012; G06F 3/017; G06T 7/50; G06T 15/20; G06T 19/20; G06T 2200/24; G06T 2219/2016

(57) ABSTRACT

A head-wearable electronic device includes at least one processor including processing circuitry, a display assembly including a display, and memory, storing one or more programs configured to be executed by the at least one processor individually and/or collectively, and including one or more storage media, and at least one processor, individually and/or collectively, is configured to execute the instructions and to cause the head-wearable electronic device to: while displaying a virtual object in a 3D space provided through the display assembly, enter a touch input mode recognizing a hand of a user being contacted on a user interface (UI) object as a user input, based on entering the touch input mode, identify first depth data of the virtual object, and, based on identifying that the first depth data of the virtual object is outside of a reference depth range, change a display location of the virtual object by adjusting the first depth data of the virtual object to second depth data within the reference depth range.

### CROSS-REFERENCE TO RELATED APPLICATIONS

This application is a continuation of International Application No. PCT/KR2025/007823 designating the United States, filed on Jun. 9, 2025, in the Korean Intellectual Property Receiving Office and claiming priority to Korean Patent Application Nos. 10-2024-0117114, filed on Aug. 29, 2024, and 10-2024-0140614, filed on Oct. 15, 2024, in the Korean Intellectual Property Office, the disclosures of each of which are incorporated by reference herein in their entireties.

### BACKGROUND

### Field

The disclosure relates to a head-wearable electronic device, a method, and a non-transitory computer-readable storage medium for a touch input in a three-dimensional space.

### Description of Related Art

In order to provide an enhanced user experience, an electronic device that provides an augmented reality (AR) service displaying information generated by a computer in connection with an external object in the real-world is being developed. The electronic device may be a head-wearable electronic device that may be worn by a user. The electronic device may be AR glasses and/or a head-mounted device (HMD).

The above-described information may be provided as a related art for the purpose of helping understanding of the present disclosure. No assertion or determination is made as to whether any of the above-described descriptions may be applied as a prior art related to the present disclosure.

### SUMMARY

According to an example embodiment, a head-wearable electronic device is described. The head-wearable electronic device may comprise at least one processor comprising processing circuitry, a display assembly, and memory, storing one or more programs configured to be executed by the at least one processor individually and/or collectively, comprising one or more storage media. The one or more programs may include instructions to cause the head-wearable electronic device to display a virtual object in a three-dimensional (3D) space provided through the display assembly. The one or more programs may include instructions to cause the head-wearable electronic device to, while displaying the virtual object in the 3D space, enter a touch input mode recognizing a hand of a user being contacted on a user interface (UI) object as a user input. The one or more programs may include instructions to cause the head-wearable electronic device to, based on entering the touch input mode, identify first depth data of the virtual object. The one or more programs may include instructions to cause the head-wearable electronic device to, based on identifying that the first depth data of the virtual object is outside of a reference depth range, change a display location of the virtual object by adjusting the first depth data of the virtual object to second depth data within the reference depth range.

According to an example embodiment, a method is described. The method may be executed in a head-wearable electronic device comprising a display assembly. The method may comprise displaying a virtual object in a three-dimensional (3D) space provided through the display assembly. The method may comprise, while displaying the virtual object in the 3D space, entering a touch input mode recognizing a hand of a user being contacted on a user interface (UI) object as a user input. The method may comprise, based on entering the touch input mode, identifying first depth data of the virtual object. The method may comprise, based on identifying that the first depth data of the virtual object is outside of a reference depth range, changing a display location of the virtual object by adjusting the first depth data of the virtual object to second depth data within the reference depth range.

According to an example embodiment, non-transitory computer-readable storage media is described. The non-transitory computer-readable storage media may store one or more programs. The one or more programs may include, when executed by a head-wearable electronic device including a display assembly, instructions to cause the head-wearable electronic device to display a virtual object in a three-dimensional (3D) space provided through the display assembly. The one or more programs may include, when executed by the head-wearable electronic device, instructions to cause the head-wearable electronic device to, while displaying the virtual object in the 3D space, enter a touch input mode recognizing a hand of a user being contacted on a user interface (UI) object as a user input. The one or more programs may include, when executed by the head-wearable electronic device, instructions to cause the head-wearable electronic device to, based on entering the touch input mode, identify first depth data of the virtual object. The one or more programs may include, when executed by the head-wearable electronic device, instructions to cause the head-wearable electronic device to, based on identifying that the first depth data of the virtual object is outside of a reference depth range, change a display location of the virtual object by adjusting the first depth data of the virtual object to second depth data within the reference depth range.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example of an error in performing a touch input on a virtual object in a virtual 3D space according to various embodiments;

FIG. 2 is a block diagram illustrating an example configuration of a head-wearable electronic device according to various embodiments;

FIG. 3 is a flowchart illustrating example operations of a head-wearable electronic device for identifying first depth data of a virtual object according to various embodiments;

FIG. 4 is a flowchart illustrating example operations of a head-wearable electronic device according to whether first depth data of a virtual object is within a reference depth range according to various embodiments;

FIG. 5 is a diagram illustrating an example of whether first depth data of a virtual object is within a reference depth range according to various embodiments;

FIG. 6 is a diagram illustrating an example of adjusting a first size of a virtual object to a second size within a reference size range according to various embodiments;

FIG. 7 is a flowchart illustrating example operations of a head-wearable electronic device for comparing second depth data of an external object with third depth data within a reference depth range according to various embodiments;

FIG. 8 is a diagram illustrating an example of second depth data of an external object smaller than a reference depth range and second depth data of an external object bigger than the reference depth range according to various embodiments;

FIG. 9 is a diagram illustrating an example of changing a display location of a virtual object according to various embodiments;

FIG. 10 is a flowchart illustrating example operations of a head-wearable electronic device for comparing second depth data of an external object with reference depth data according to various embodiments;

FIG. 11 is a diagram illustrating an example of changing a display location of a virtual object by comparing second depth data of an external object with reference depth data according to various embodiments;

FIG. 12 is a diagram illustrating an example of changing display locations of a plurality of virtual objects according to various embodiments;

FIG. 13 is a diagram illustrating an example of maintaining a display location of a virtual object according to movement of a user and a change in a direction of a head of the user according to various embodiments;

FIG. 14 is a flowchart illustrating example operations of a head-wearable electronic device for changing a display location of a virtual object again according to various embodiments;

FIG. 15 is a diagram illustrating an example of changing a size and a display location of a virtual object again according to various embodiments;

FIG. 16 is a block diagram illustrating an example configuration of a head-wearable electronic device according to various embodiments; and

FIG. 17 is a block diagram illustrating an example electronic device in a network environment according to various embodiments.

### DETAILED DESCRIPTION

Hereinafter, various example embodiments of the disclosure will be described in greater detail with reference to the drawings. However, the present disclosure may be implemented in several different forms and is not limited to the example embodiments described herein. With respect to a description of the drawing, the same or similar reference numerals may be used for the same or similar components. In addition, in the drawings and the related descriptions, a description of a well-known function and configuration may be omitted for clarity and brevity.

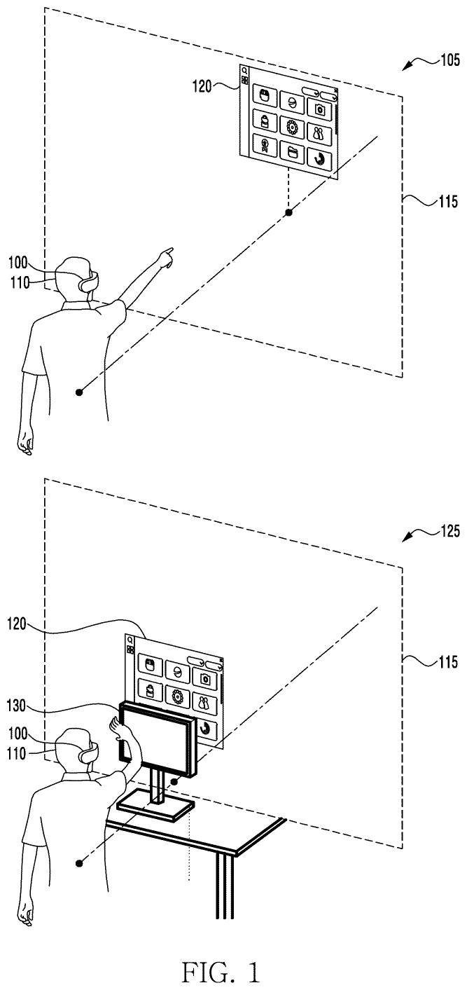

FIG. 1 is a diagram illustrating an example of an error in performing a touch input on a virtual object in a virtual 3D space according to various embodiments.

Referring to FIG. 1, a head-wearable electronic device 100 may include a head-mounted display (HMD) wearable on a head of a user 110. The head-wearable electronic device 100 may include, for example, and without limitation, a head-mounted display (HMD) device, a headgear electronic device, a glasses-type (or goggle-type) electronic device, a video see-through or visible see-through (VST) device, an extended reality (XR) device, a virtual reality (VR) device, and/or an augmented reality (AR) device, etc.

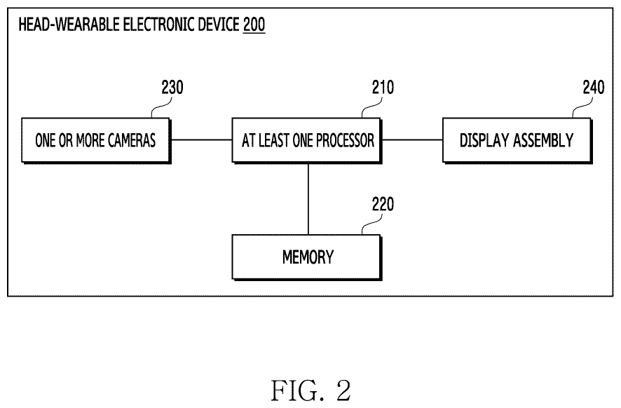

The head-wearable electronic device 100 may include a display assembly (e.g., a display assembly 240 of FIG. 2). The head-wearable electronic device 100 may provide a virtual three-dimensional (3D) space 115 through the display assembly. The head-wearable electronic device 100 may display a virtual object 120 (or a UI object, or a visual object) in the virtual 3D space 115. The head-wearable electronic device 100 may receive an input for the virtual object 120.

The head-wearable electronic device 100 may receive an input for the virtual object 120 based on various methods. The head-wearable electronic device 100 may receive an input for the virtual object based on a user gesture (e.g., a pinch gesture) for the virtual object 120. The user gesture may be performed while a hand of the user 110 is spaced apart from the virtual object 120. The input for the virtual object 120 based on the user gesture may be received from the virtual object 120 while the hand the user 110 is spaced apart, but it may be required to perform a plurality of tracking (e.g., hand tracking, eye tracking, and/or controller tracking) to identify the user gesture. Since the user gesture is identified based on the plurality of tracking, accuracy of the input for the virtual object 120 based on the user gesture may be relatively low.

The input for the virtual object 120 based on the user gesture may not be intuitive to the user 110. The input for the virtual object 120 based on the user gesture that is not intuitive to the user 110 may have relatively low accuracy and may enable the user to feel tired. The head-wearable electronic device 100 may receive the input for the virtual object 120 based on a method of recognizing the hand of the user 110 being contacted on the virtual object 120 as an input for the virtual object 120 in order to address this problem. In order to address this problem of the input for the virtual object 120 based on the user gesture, the head-wearable electronic device 100 may receive the input for the virtual object 120 based on a method of recognizing the hand of the user 110 being contacted on the virtual object 120 as the input for the virtual object 120. The input for the virtual object 120 based on the hand of the user 110 being contacted with the virtual object 120 may be defined as a touch input for the virtual object 120.

A state 105 and a state 125 may be described as a state having an error in receiving the touch input for the virtual object 120. In the state 105, the head-wearable electronic device 100 may display the virtual object 120 on a location relatively far from the user 110 within the virtual 3D space 115. In the state 105, the user 110 may not move in a direction with respect to the virtual object 120 and may not perform the touch input for the virtual object 120. In order for the head-wearable electronic device 100 to receive the touch input for the virtual object 120, it may be required for the user 110 to move in the direction with respect to the virtual object 120. The user 110 may feel uncomfortable by moving in the direction with respect to the virtual object 120 to perform the touch input for the virtual object 120.

In the state 125, the head-wearable electronic device 100 may display the virtual object 120 within the virtual 3D space 115. An external object 130 may be located between the user 110 and the virtual object 120. The external object 130 may be located in an actual environment distinguished from the virtual 3D space 115. The head-wearable electronic device 100 may have an error in receiving the touch input for the virtual object 120 by the external object 130 located in the actual environment. The user 110 may feel uncomfortable in performing the touch input for the virtual object 120 by the external object 130 located in the actual environment.

A method for addressing this discomfort of the touch input for the virtual object 120 may be required. To address this discomfort, the head-wearable electronic device 100 may change a display location of the virtual object 120. In order to change the display location of the virtual object 120, depth data of the virtual object 120 and depth data of the external object 130 may be used.

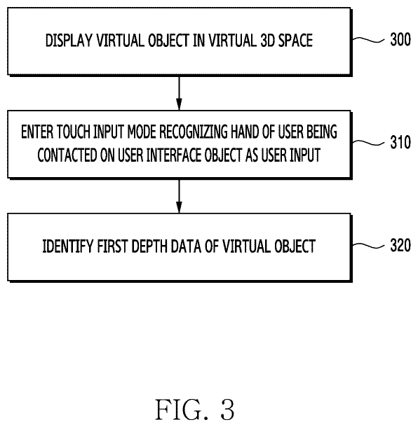

The head-wearable electronic device 100 may execute operations illustrated and described in greater detail below with reference to FIGS. 3 to 15 in order to change the display location of the virtual object 120. The head-wearable electronic device 100 may include components for executing the operations. The components may be illustrated and described in greater detail below with reference to FIG. 2.

FIG. 2 is a block diagram illustrating an example configuration of a head-wearable electronic device according to various embodiments.

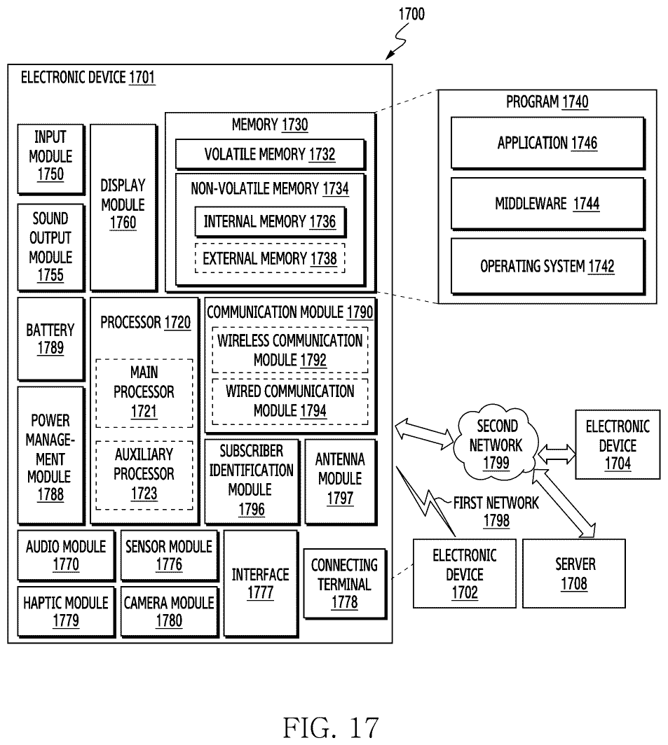

Referring to FIG. 2, a head-wearable electronic device 200 may be described as a head-mounted display (HMD) device that may be worn on a head of a user, a headgear electronic device, a glasses-type (or goggle-type) device, a video see-through or visible see-through (VST) device, an extended reality (XR) device, a virtual reality (VR) device, and/or an augmented reality (AR) device, or the like. The head-wearable electronic device 200 may include at least a portion of an electronic device 1701 of FIG. 17, or may correspond to the at least a portion of the electronic device 1701 of FIG. 17. The head-wearable electronic device 200 may include at least one processor (e.g., including processing circuitry) 210, memory 220, one or more cameras 230, and a display assembly (e.g., including a display) 240.

According to an embodiment, the at least one processor 210 may include various processing circuitry. The at least one processor 210 may include a central processing unit (CPU) (e.g., including processing circuitry). The at least one processor 210 may include a graphic processing unit (GPU) (e.g., including processing circuitry) and a neural processing unit (NPU) (e.g., including processing circuitry). The at least one processor 210 may be configured to control the memory 220, the one or more cameras 230, and the display assembly 240. The at least one processor 210 may be configured to execute instructions stored in the memory 220 individually or collectively, in order to cause the head-wearable electronic device 200 (or the head-wearable electronic device 100) to perform at least some of the operations illustrated and described with reference to FIG. 1. The at least one processor 210 may be configured to execute instructions stored in the memory 220 individually or collectively, in order to cause the head-wearable electronic device 200 to perform at least some of the operations to be illustrated and described in greater detail below with reference to FIGS. 3 to 15.

According to an embodiment, the memory 220 may include one or more storage mediums. The memory 220 may store various data used by at least one component (e.g., the at least one processor 210, the memory 220, the one or more cameras 230, and/or the display assembly 240) of the head-wearable electronic device 200. Data may include input data or output data for software and a command related thereto. The memory 220 may include a volatile memory or a non-volatile memory.

According to an embodiment, the one or more cameras 230 may include one or more optical sensors (e.g., a charged coupled device (CCD) sensor and/or a complementary metal oxide semiconductor (CMOS) sensor) that generate an electrical signal indicating color and/or brightness of light. The one or more cameras 230 may be described as an image sensor. The one or more cameras 230 may be available to obtain images with respect to a space (or a surrounding environment) in front of the head-wearable electronic device 200. At least a portion of the one or more cameras 230 may have an FOV corresponding to a field of view (FOV) of eyes of the user. An FOV of a portion of the one or more cameras 230 may be different from an FOV of another portion of the one or more cameras 230.

According to an embodiment, the display assembly 240 may be configured to visualize information (or a signal) provided from the at least one processor 210. The display assembly 240 may be disposed to face the eyes of the user wearing the head-wearable electronic device 200. The display assembly 240 may be configured to provide a virtual 3D space. The display assembly 240 may be configured to display a virtual object in the virtual 3D space. The display assembly 240 may include at least one display.

The head-wearable electronic device 200 illustrated in the description of FIG. 2 may execute at least some of the operations illustrated and described in greater detail below with reference to FIGS. 3 to 15. The operations illustrated and described in the description of FIGS. 3 to 15 may be caused by (or within) the head-wearable electronic device 200 under control of the at least one processor 210.

FIG. 3 is a flowchart illustrating example operations of a head-wearable electronic device for identifying first depth data of a virtual object according to various embodiments.

Referring to FIG. 3, in operation 300, at least one processor 210 may provide a virtual three-dimensional (3D) space (e.g., the virtual 3D space 115 of FIG. 1) through a display assembly 240. The at least one processor 210 may display a virtual object (e.g., the virtual object 120 of FIG. 1) in the virtual 3D space. The virtual object may include a user interface (UI) object and/or a window. The virtual object may be provided from a software application running in a head-wearable electronic device 200. The virtual object may include executable objects. While the virtual object is displayed in the virtual 3D space, the following operations (operation 310 and operation 320) may be performed.

In operation 310, according to an embodiment, the at least one processor 210 may enter a touch input mode recognizing a hand of a user (e.g., the user 110 of FIG. 1) being contacted on a user interface object as a user input while displaying the virtual object in the virtual 3D space. The touch input mode may be defined as a direct touch input mode. The at least one processor 210 may recognize the hand of the user being contacted with the virtual object in the touch input mode as a touch input for the virtual object. The at least one processor 210 may identify that the hand of the user being contacted with the virtual object through one or more cameras 230. In the touch input mode, the at least one processor 210 may provide a function mapped to the virtual object based on the hand of the user being contacted with the virtual object.

According to an embodiment, the touch input mode may be distinguished from another input mode that receives an input for the virtual object by a different method other than the touch input. In the other input mode, the at least one processor 210 may receive the input for the virtual object based on a user gesture (e.g., a pinch gesture) performed while the hand of the user is spaced apart from the virtual object. In the other input mode, the at least one processor 210 may provide a function mapped to the virtual object, based on the user gesture for the virtual object.

According to an embodiment, the at least one processor 210 may enter the touch input mode based on a user input and/or an event. As a non-limiting example, the user input for entering the touch input mode may include an input for the virtual object (or a virtual button) in the virtual 3D space. The at least one processor 210 may enter the touch input mode based on switching from the other input mode to the touch input mode. The at least one processor 210 may enter the touch input mode for a portion of virtual objects among a plurality of virtual objects displayed in the virtual 3D space. According to entering the touch input mode for the portion of virtual objects, the at least one processor 210 may receive a touch input for the portion of virtual objects, and may receive an input for remaining virtual objects among the plurality of virtual objects based on a user gesture.

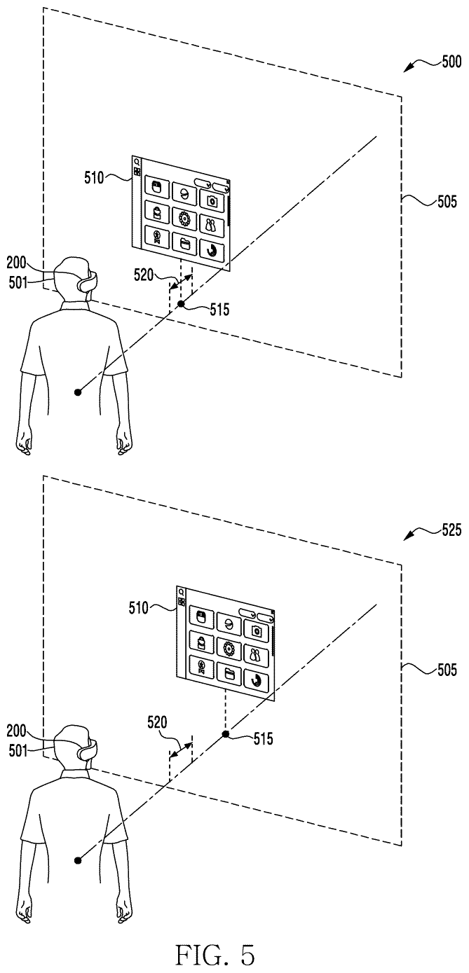

In operation 320, according to an embodiment, the at least one processor 210 may identify first depth data (e.g., first depth data 515 of FIG. 5) of the virtual object based on entering the touch input mode. As a non-limiting example, when a location in the virtual 3D space is defined by an x-axis coordinate, a y-axis coordinate, and a z-axis coordinate, depth data of the virtual object may indicate a z-axis coordinate of the virtual object. As a non-limiting example, the depth data may indicate a z-axis coordinate of a representative location in a region or a space in which the virtual object is displayed. The at least one processor 210 may identify a distance from the user to the virtual object by identifying the depth data of the virtual object.

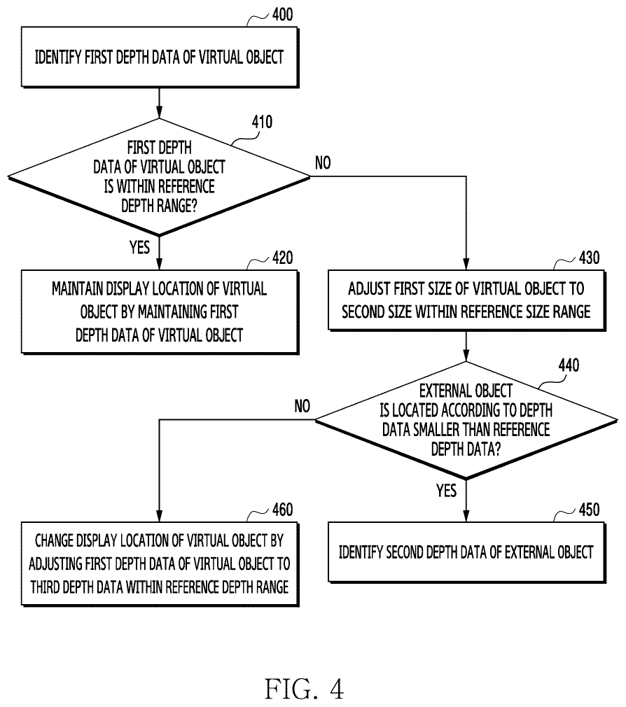

According to an embodiment, the at least one processor 210 may determine whether to maintain a display location of the virtual object based on the identified first depth data of the virtual object. Using the first depth data of the virtual object to determine whether to maintain the display location of the virtual object will be illustrated and described in greater detail below with reference to FIG. 4.

FIG. 4 is a flowchart illustrating example operations of a head-wearable electronic device according to whether first depth data of a virtual object is within a reference depth range according to various embodiments.

Referring to FIG. 4, according to an embodiment, in operation 400, at least one processor 210 may identify first depth data of a virtual object based on entering a touch input mode. Operation 400 may correspond to operation 320 of FIG. 3.

According to an embodiment, in operation 410, the at least one processor 210 may identify whether the identified first depth data of the virtual object is within a reference depth range (e.g., the reference depth range 520 of FIG. 5). The reference depth range may refer, for example, to a range of depth data in which a hand of a user may be located without the user moving. The reference depth range may be predetermined (e.g., specified) or set (or changed) by the user. As a non-limiting example, the reference depth range may be set according to depth data of a wrist of the user when the user extends the hand in a front direction. However, the disclosure is not limited thereto. Whether the first depth data of the virtual object is within the reference depth range will be illustrated and described in greater detail below with reference to FIG. 5.

According to an embodiment, in operation 420, the at least one processor 210 may maintain a display location of the virtual object by maintaining the first depth data of the virtual object based on identifying that the first depth data (e.g., the first depth data 515 of FIG. 5) of the virtual object (e.g., the virtual object 510 of FIG. 5) is within the reference depth range (e.g., the reference depth range 520 of FIG. 5). The virtual object displayed according to the first depth data within the reference depth range in the virtual 3D space may receive a touch input from the user without the user moving (or without the user bending an arm). As performing the touch input on the displayed virtual object according to the first depth data within the reference depth range in the virtual 3D space does not cause inconvenience to the user, changing the display location of the virtual object may not be required.

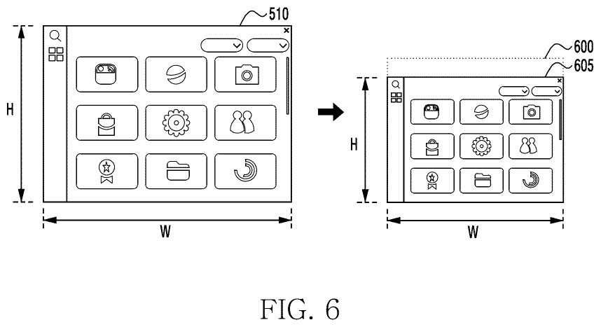

According to an embodiment, in operation 430, the at least one processor 210 may identify a first size of the virtual object based on identifying that the first depth data of the virtual object is outside the reference depth range. The at least one processor 210 may adjust the first size of the virtual object to a second size within a reference size range. The at least one processor 210 may identify an aspect ratio of the virtual object. The at least one processor 210 may adjust the first size of the virtual object to the second size while maintaining the identified aspect ratio of the virtual object. Adjusting a size of the virtual object will be illustrated and described in greater detail below with reference to FIG. 6.

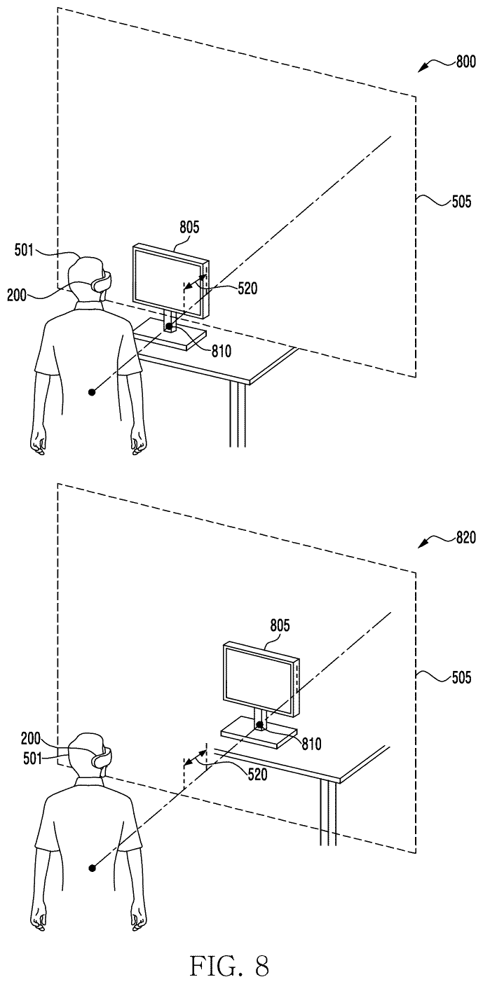

According to an embodiment, in operation 440, the at least one processor 210 may identify whether an external object (e.g., an external object 805 of FIG. 8) is located according to depth data smaller than the reference depth range using one or more cameras 230. For example, in case that the external object is located according to the depth data smaller than the reference depth range, receiving the touch input for the virtual object by the external object may have an error. The at least one processor 210 may obtain images with respect to a space in front of a head-wearable electronic device 200 through the one or more cameras 230. For example, the at least one processor 210 may identify whether the external object is located according to the depth data smaller than the reference depth range using at least a portion of the images in which the external object is included. According to an embodiment, in operation 450, the at least one processor 210 may identify second depth data of the external object based on the external object being located according to the depth data smaller than reference depth data. The at least one processor 210 may obtain images with respect to the space in front of the head-wearable electronic device 200 through the one or more cameras 230. The at least one processor 210 may identify the second depth data of the external object using at least a portion of the images in which the external object is included. In order to change a display location of a window to a front direction of the user, the at least one processor 210 may identify the second depth data of the external object located in the front direction of the user. The external object may be described as the external object located in the front direction of the user of the head-wearable electronic device 200. As a non-limiting example, the at least one processor 210 may identify depth values of pixels of each of the images and identify the second depth data of the external object using the depth values.

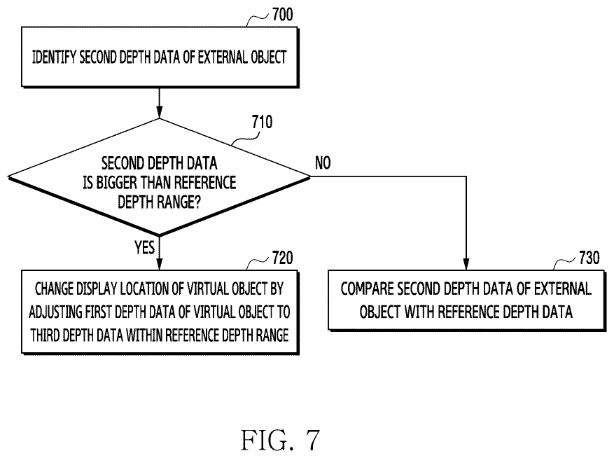

According to an embodiment, in order to address the inconvenience for the touch input of the user caused by the external object, the second depth data of the external object may be used. The at least one processor 210 may change the display location of the window according to the second depth data of the external object. Changing the display location of the window according to the second depth data of the external object will be illustrated and described in greater detail below with reference to FIG. 7.

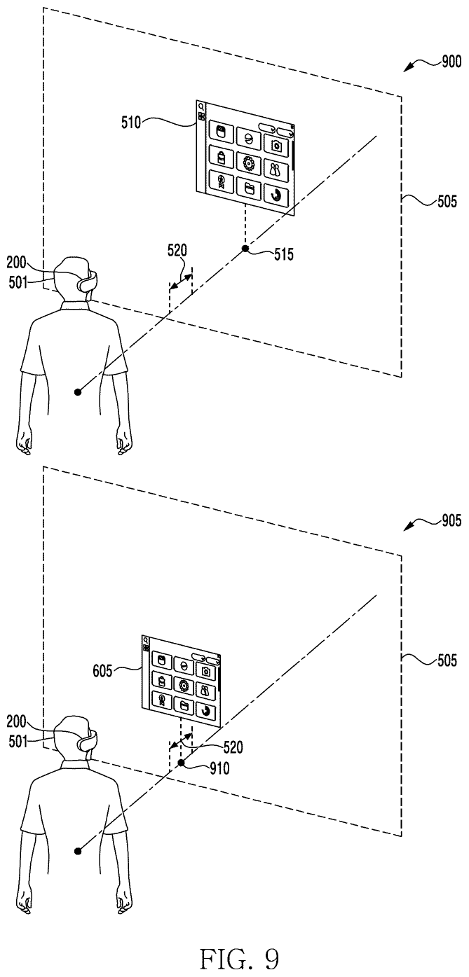

According to an embodiment, in operation 460, the at least one processor 210 may adjust the first depth data of the window to third depth data within the reference depth range, based on the external object not being located according to the depth data smaller than the reference depth data. For example, the at least one processor 210 may change the display location of the window by adjusting the first depth data of the window to the third depth data. For example, the at least one processor 210 may display the window according to the third depth data in the virtual 3D space. Changing the display location of the window by adjusting the first depth data of the window to the third depth data will be illustrated and described in greater detail below with reference to FIG. 9.

FIG. 5 is a diagram illustrating an example of whether first depth data of a virtual object is within a reference depth range according to various embodiments.

Referring to FIG. 5, according to an embodiment, at least one processor 210 may identify first depth data 515 of a virtual object 510 displayed in a virtual 3D space 505. The at least one processor 210 may identify whether the identified first depth data 515 is within the reference depth range 520.

According to an embodiment, in a state 500, the at least one processor 210 may identify that the first depth data 515 of the virtual object 510 is within the reference depth range 520. As the first depth data 515 is within the reference depth range 520, the virtual object 510 may be located within a region capable of receiving a touch input without movement of the user. As the virtual object 510 is located within the region capable of receiving the touch input without the movement of the user, changing a display location of the virtual object 510 may not be required. The at least one processor 210 may perform operation 420 of FIG. 4 based on identifying that the first depth data 515 is within the reference depth range 520.

According to an embodiment, in a state 525, the at least one processor 210 may identify that the first depth data 515 of the virtual object 510 is outside the reference depth range 520. As the first depth data 515 is outside the reference depth range 520, the virtual object 510 may be relatively close to or relatively far from a user 501. As the virtual object 510 is relatively close to the user 501, the user 501 may be required to bend an arm (or a wrist) to perform the touch input for the virtual object 510. As the virtual object 510 is relatively far from the user 501, the user 501 may be required to move in a direction with respect to the virtual object 510 to perform the touch input for the virtual object 510. In the state 525, the at least one processor 210 may change the display location of the virtual object 510 to address inconvenience of the user 501 caused to perform the touch input for the virtual object 510. The at least one processor 210 may perform operation 430 and operation 440 of FIG. 4 based on identifying that the first depth data 515 is outside the reference depth range 520.

FIG. 6 is a diagram illustrating an example of adjusting a first size of a virtual object to a second size within a reference size range according to various embodiments.

Referring to FIG. 6, according to an embodiment, at least one processor 210 may identify a first size of a virtual object 510 and/or an aspect ratio W:H of the virtual object 510 based on identifying that first depth data of the virtual object 510 is outside a reference depth range. The at least one processor 210 may identify a size to which the virtual object 510 is to be rendered based on entering a touch input mode. Since the virtual object 510 is displayed according to the first depth data outside the reference depth range, it may have the first size that is a relatively large (or relatively small). In order to display the virtual object 510 according to depth data within the reference depth range, adjusting the relatively large (or relatively small) first size of the virtual object 510 may be required.

According to an embodiment, the at least one processor 210 may adjust the first size of the virtual object 510 to a second size within a reference size range 600. The reference size range 600 may refer, for example, to a size range of a virtual object 605 set for a user to perform a touch input for the virtual object 605 when displaying the virtual object 605 according to the depth data within the reference depth range. The reference size range 600 may be predetermined (e.g., specified) or set (or changed) by the user. The reference size range 600 may be configured with a reference height value (e.g., 30 cm) and a reference width value (e.g., 30 cm).

According to an embodiment, the at least one processor 210 may determine the second size of the virtual object 605 based on the aspect ratio W:H of the virtual object 510 and/or the reference size range 600. The virtual object 605 having the second size may have an aspect ratio W:H corresponding to the aspect ratio W:H of the virtual object 510 having the first size. The at least one processor 210 may adjust the first size of the virtual object 510 to the second size while maintaining the aspect ratio W:H of the virtual object 510. The second size may be determined as the maximum size within the reference size range 600 in which the aspect ratio W:H may be maintained. A width value W of the virtual object 605 having the second size may be determined according to a smaller value among a width value and a height value of a reference size. As a non-limiting example, the width value W of the virtual object 605 having the second size corresponds to the reference width value of the reference size range 600, and the height value H of the virtual object 605 having the second size may be smaller than the reference height value of the reference size range 600. However, the disclosure is not limited thereto. The at least one processor 210 may change a size of the virtual object 510 by maintaining the aspect ratio W:H of the virtual object 510 and adjusting the first size of the virtual object 510 to the second size. The at least one processor 210 may store the first size to adjust the second size of the virtual object 510 to the first size again.

FIG. 7 is a flowchart illustrating example operations of a head-wearable electronic device for comparing second depth data of an external object with third depth data within a reference depth range according to various embodiments.

Referring to FIG. 7, according to an embodiment, in operation 700, at least one processor 210 may identify the second depth data of the external object using one or more cameras 230. Operation 700 may correspond to operation 440 of FIG. 4.

According to an embodiment, in operation 710, the at least one processor 210 may compare the second depth data of the external object with the third depth data within the reference depth range. The at least one processor 210 may identify whether the second depth data is bigger (e.g., greater) than the reference depth range by comparing the second depth data of the external object with the reference depth range. Whether the second depth data of the external object is bigger than the reference depth range will be illustrated and described in greater detail below with reference to FIG. 8.

According to an embodiment, in operation 720, the at least one processor 210 may adjust first depth data of a window to the third depth data (e.g., the third depth data 901 of FIG. 9) within the reference depth range based on identifying that the second depth data (e.g., the second depth data 810 of FIG. 8) of the external object (e.g., the external object 805 of FIG. 8) is bigger than the reference depth range (e.g., the third depth data 520 of FIG. 8). The at least one processor 210 may change a display location of the window by adjusting the first depth data of the window to the third depth data. For example, the at least one processor 210 may display the window according to the third depth data in a virtual 3D space. Changing the display location of the window by adjusting the first depth data of the window to the third depth data will be illustrated and described in greater detail below with reference to FIG. 9.

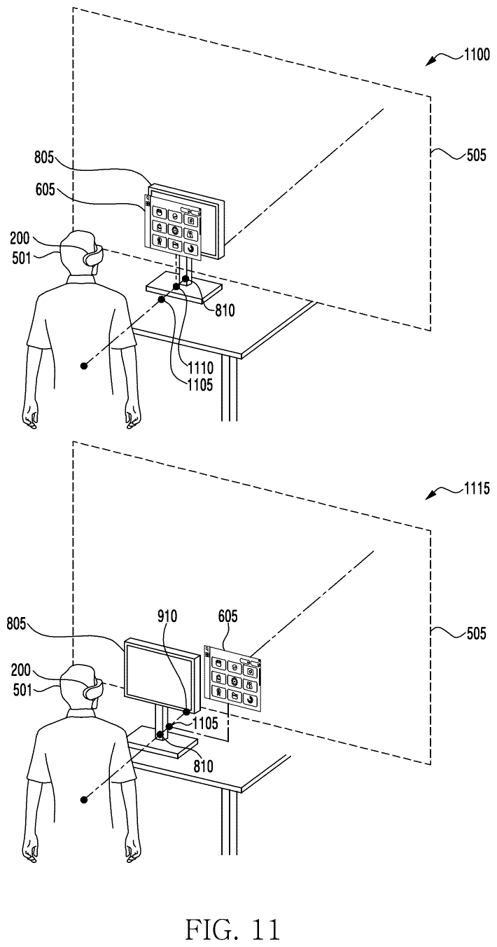

According to an embodiment, in operation 730, the at least one processor 210 may compare the second depth data of the external object with reference depth data (e.g., reference depth data 1105 of FIG. 11) based on identifying that the second depth data of the external object is smaller (e.g., less) than the third depth data within the reference depth range. The reference depth data may refer, for example, to a minimum depth data in which a user may perform a touch input without movement. For example, the reference depth data may be predetermined (e.g., specified) or set (or changed) by the user. As a non-limiting example, the reference depth data may correspond to a length of a hand of the user. However, the disclosure is not limited thereto.

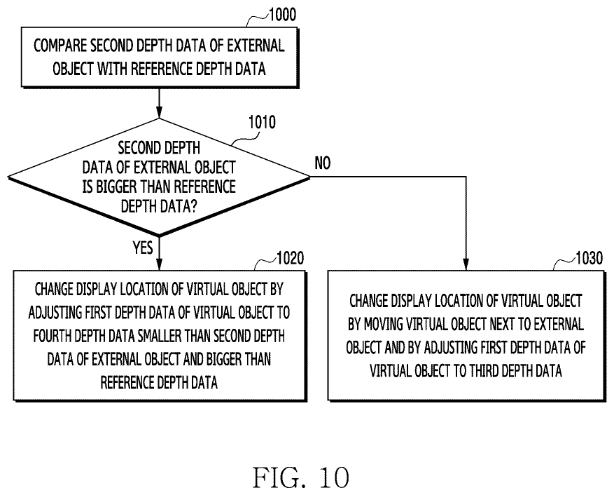

According to an embodiment, the at least one processor 210 may change the display location of the window by comparing the second depth data of the external object with the reference depth data. Changing the display location of the window by comparing the second depth data of the external object with the reference depth data will be illustrated and described in greater detail below with reference to FIG. 10.

FIG. 8 is a diagram illustrating an example of second depth data of an external object smaller than a reference depth range and second depth data of an external object bigger than the reference depth range according to various embodiments.

Referring to FIG. 8, according to an embodiment, at least one processor 210 may identify second depth data 810 of an external object 805 using one or more cameras 230. The at least one processor 210 may identify whether the second depth data 810 is bigger than a reference depth range 520 by comparing the second depth data 810 with the reference depth range 520. The at least one processor 210 may compare the second depth data 810 with the reference depth range 520 to identify whether the external object 805 is located closer to a user than a location at which a visual object is to be displayed. In case that the external object 805 is located closer to the user than the location at which the visual object is to be displayed, receiving a touch input of a virtual object by the external object 805 may have an error.

According to an embodiment, in a state 800, the at least one processor 210 may identify that the second depth data 810 of the external object 805 is smaller than the reference depth range 520. As the second depth data 810 of the external object 805 is smaller than the reference depth range 520, receiving the touch input for the virtual object to be displayed according to depth data within the reference depth range 520 may have an error by the external object 805. As receiving the touch input for the virtual object to be displayed according to the depth data within the reference depth range 520 has an error by the external object 805, displaying the virtual object according to depth data smaller than the second depth data 810 of the external object 805 may be required. The at least one processor 210 may perform operation 730 of FIG. 7 based on identifying that the second depth data 810 of the external object 805 is smaller than the reference depth range 520.

According to an embodiment, in a state 820, the at least one processor 210 may identify that the second depth data 810 of the external object 805 is bigger than the reference depth range 520. As the second depth data 810 of the external object 805 is bigger (e.g., greater) than the reference depth range 520, the at least one processor 210 may receive the touch input for the virtual object to be displayed according to the depth data in the reference depth range 520 without interference from the external object 805. The at least one processor 210 may perform operation 720 of FIG. 7 based on identifying that the second depth data 810 of the external object 805 is bigger than the reference depth range 520.

FIG. 9 is a diagram illustrating an example of changing a display location of a virtual object according to various embodiments.

Referring to FIG. 9, according to an embodiment, a state 900 may be described as a state before a display location of a virtual object 530 is changed. In the state 900, at least one processor 210 may display the virtual object 530 having a first size according to first depth data 515, in a virtual 3D space 505. The at least one processor 210 may enter a touch input mode while displaying the virtual object 530 in the virtual 3D space 505. The at least one processor 210 may identify the first depth data 515 of the virtual object 530 outside a reference depth range 520 based on entering the touch input mode. Based on identifying that the first depth data 515 is outside the reference depth range 520, the at least one processor 210 may identify that second depth data of an external object identified using one or more cameras is bigger than third depth data 910 within the reference depth range 520 (or that the external object is not located according to the second depth data smaller than the third depth data 910).

According to an embodiment, a head-wearable electronic device 200 may switch from the state 900 to a state 905, based on identifying that the second depth data of the external object is bigger than the third depth data 910 (or that the external object is not located according to the second depth data smaller than the third depth data 910). The state 905 may be described as a state in which the display location of the virtual object 605 is changed. In the state 905, the at least one processor 210 may change a size of the virtual object 510 by adjusting the first size of the virtual object 510 to a second size. Adjusting the first size of the virtual object 510 to the second size may explained and understood by referring to the description of FIG. 6.

According to an embodiment, the at least one processor 210 may change the display location of the virtual object 605 by adjusting the first depth data 515 of the virtual object 510 to the third depth data 910 within the reference depth range 520. The at least one processor 210 may display the virtual object 605 having the second size in the virtual 3D space 505 according to the third depth data 910. As the virtual object 605 has the second size within the reference size range, the virtual object 605 may be seen by the user as a size in which the user may perform a touch input. As the virtual object 605 is displayed according to the third depth data 910 within the reference depth range 520, a user 501 may perform the touch input for the virtual object 605 without moving (or without bending an arm) in a direction with respect to the virtual object 605.

According to an embodiment, the at least one processor 210 may display the virtual object 605 on a height corresponding to a height at which the head-wearable electronic device 200 is located in the virtual 3D space. As the virtual object 605 is displayed on the height corresponding to the height at which the head-wearable electronic device 200 is located, the user 501 may perform the touch input for the virtual object 605 by extending the arm in a linear direction.

According to an embodiment, the display location of the virtual object 605 may be changed while another virtual object is displayed according to depth data smaller than the third depth data 910 in the virtual 3D space 505. As the virtual object 605 is displayed according to the third depth data 910 in the virtual 3D space 505, at least a portion of the virtual object 605 may not be seen by the user 501 by the other virtual object being displayed according to the depth data smaller than the third depth data 910. The at least one processor 210 may have an error in receiving a touch input for the virtual object 605 displayed according to the third depth data 910 by the other virtual object being displayed according to the depth data smaller than the third depth data 910. In order to address this error, the at least one processor 210 may perform blur processing on the other virtual object being displayed according to the depth data smaller than the third depth data 910 based on displaying the virtual object 605 according to the third depth data 910 in the virtual 3D space 505, and may cease (or refrain from, or not receive) receiving a touch input for the other virtual object.

FIG. 10 is a flowchart illustrating example operations of a head-wearable electronic device for comparing second depth data of an external object with reference depth data according to various embodiments.

Referring to FIG. 10, according to an embodiment, in operation 1000, at least one processor 210 may compare the second depth data of the external object with the reference depth data based on identifying that the second depth data of the external object is smaller than a reference depth range. Operation 1000 may correspond to operation 730 of FIG. 7. According to an embodiment, in case that the external object is located relatively close to a user, it may have an error in receiving a touch input for a virtual object displayed in front of the external object. To address this error, displaying the virtual object next to the external object may be required.

According to an embodiment, in operation 1010, the at least one processor 210 may identify whether the second depth data of the external object is bigger than the reference depth data by comparing the second depth data of the external object with the reference depth data.

According to an embodiment, in operation 1020, the at least one processor 210 may adjust first depth data of the virtual object to fourth depth data smaller than the second depth data of the external object and bigger than the reference depth data, based on the second depth data of the external object bigger than the reference depth data. The at least one processor 210 may change a display location of the virtual object by adjusting the first depth data of the virtual object to the fourth depth data. The at least one processor 210 may display the virtual object in front of the external object by displaying the virtual object according to the fourth depth data smaller than the second depth data of the external object in a virtual 3D space.

According to an embodiment, the at least one processor 210 may receive the touch input for the virtual object without interference from the external object by displaying the virtual object according to the fourth depth data smaller than the second depth data of the external object in the virtual 3D space. As the fourth depth data is bigger than the reference depth data defined as minimum depth data in which the user may perform the touch input, the at least one processor 210 may receive the touch input for the virtual object displayed according to the fourth depth data without movement of the user. Displaying the virtual object according to the fourth depth data will be illustrated and described in greater detail below with reference to FIG. 11.

According to an embodiment, in operation 1030, the at least one processor 210 may move the virtual object next to the external object based on the second depth data of the external object smaller than the reference depth data. The at least one processor 210 may adjust the first depth data of the virtual object to the reference depth data based on the second depth data of the external object smaller than the reference depth data. The at least one processor 210 may change the display location of the virtual object by moving the virtual object next to the external object and by adjusting the first depth data of the virtual object to the reference depth data. The at least one processor 210 may display the virtual object on a location next to the external object according to the reference depth data in the virtual 3D space.

According to an embodiment, in case that the virtual object is displayed according to depth data that is smaller than the second depth data of the external object smaller than the reference depth data in the virtual 3D space, since a distance between the virtual object and the user is relatively short, it may have an error in receiving the touch input for the virtual object. In case that the virtual object is displayed according to the reference depth data in the virtual 3D space, it may have an error in receiving the touch input for the virtual object by the external object located according to the second depth data smaller than the reference depth data. To address these errors, the at least one processor 210 may display the virtual object on the location next to the external object in the virtual 3D space according to the reference depth data. Displaying the virtual object on the location next to the external object according to the reference depth data will be illustrated and described in greater detail below with reference to FIG. 11.

FIG. 11 is a diagram illustrating an example of changing a display location of a virtual object by comparing second depth data of an external object with reference depth data according to various embodiments.

Referring to FIG. 11, according to an embodiment, at least one processor 210 may identify whether an external object 805 is located according to depth data less than a reference depth range, based on entering a touch input mode. The at least one processor 210 may display a virtual object 605 (e.g., a window, or a UI) in front of the external object 805 based on the external object 805 being located according to the depth data less than the reference depth range. FIG. 11 illustrates, in case of displaying the virtual object 605, an example for determining an optimal location where the virtual object 605 is to be displayed based on a length of an arm of a user 501 and a location of the external object 805. A state 1100 may be described as a state in which second depth data 810 of the external object 805 is bigger than reference depth data 1105. In the state 1100, the at least one processor 210 may adjust first depth data (e.g., the first depth data 515 of FIG. 5) of the virtual object 605 to fourth depth data 1110, based on the second depth data 810 of the external object 805 bigger than the reference depth data 1105. The fourth depth data 1110 may be smaller than the second depth data 810 of the external object 805 and bigger than the reference depth data 1105. The at least one processor 210 may change a display location of the virtual object 605 by adjusting the first depth data of the virtual object 605 to the fourth depth data 1110. The at least one processor 210 may display the virtual object 605 according to the fourth depth data 1110 in a virtual 3D space 505 by changing the display location of the virtual object 605.

According to an embodiment, the virtual object 605 may be located in front of the external object 805 in the virtual 3D space 505 by displaying the virtual object 605 according to the fourth depth data 1110 smaller than the second depth data 810 of the external object 805 in the virtual 3D space 505. As the virtual object 605 is located in front of the external object 805 in the virtual 3D space 505, the at least one processor 210 may receive a touch input for the virtual object 605 without interference from the external object 805.

According to an embodiment, by displaying the virtual object 605 according to the fourth depth data 1110 bigger than the reference depth data 1105 in the virtual 3D space 505, the virtual object 605 may be located according to depth data bigger than minimum depth data in which the user 501 may perform the touch input. Since the fourth depth data 1110 of the virtual object 605 is bigger than the reference depth data 1105 defined as the minimum depth data in which the user 501 may perform the touch input, receiving the touch input for the virtual object 605 may not have an error.

According to an embodiment, the at least one processor 210 may change a size of the virtual object 605 by adjusting a first size of the virtual object 605 to a second size within a reference size range. The at least one processor 210 may display the virtual object 605 having the second size in the virtual 3D space 505 according to the fourth depth data 1110, by changing the size of the virtual object 605. As the virtual object 605 displayed according to the fourth depth data 1110 has the second size within the reference size range, the virtual object 605 may be seen to the user as a size in which the user may perform the touch input. As the virtual object 605 is displayed according to the fourth depth data 1110 smaller than third depth data (e.g., the third depth data 815 of FIG. 8) within the reference depth range (e.g., the reference depth range 520 of FIG. 5), the user 501 may perform the touch input for the virtual object 605 without moving in the direction with respect to the virtual object 605.

According to an embodiment, a state 1115 may be described as a state in which the second depth data 810 of the external object 805 is smaller than the reference depth data 1105. In the state 1115, the at least one processor 210 may adjust the first depth data of the virtual object 605 to the third depth data 910 based on the second depth data 810 of the external object 805 smaller than the reference depth data 1105. The at least one processor 210 may change the display location of the virtual object 605 by adjusting the first depth data of the virtual object 605 to the third data 910. The at least one processor 210 may display the virtual object 605 according to the third depth data 910 in the virtual 3D space 505 by changing the display location of the virtual object 605.

According to an embodiment, when the virtual object 605 is displayed in a front direction of the user 501 according to the third depth data 910 bigger than the second depth data 810 of the external object 805 in the virtual 3D space 505, it may have an error in receiving the touch input for the virtual object 605 by the external object 805 located in front of the virtual object 605. To address this error, the at least one processor 210 may display the virtual object 605 in the virtual 3D space 505 on a location next to the external object 805 rather than in the front direction of the user, according to the third depth data 910. As the virtual object 605 is located next to the external object 805 in the virtual 3D space 505, the at least one processor 210 may receive the touch input for the virtual object 605 without interference from the external object 805.

According to an embodiment, as the at least one processor 210 displays the virtual object 605 according to the third depth data 910 in the virtual 3D space 505, so that the virtual object 605 may be located according to optimal depth data in which the user 501 may perform the touch input. Since the virtual object 605 is displayed according to the third depth data 910 which may be referred to as the optimal depth data in which the user 501 may perform the touch input, receiving the touch input for the virtual object 605 may not have an error.

The at least one processor 210 may change the size of the virtual object 605 by adjusting the first size of the virtual object 605 to the second size within the reference size range. By changing the size of the virtual object 605, the at least one processor 210 may display the virtual object 605 having the second size in the virtual 3D space 505 next to the external object 805 according to the third depth data 910. As the virtual object 605 has the second size within the reference size range, the virtual object 605 displayed according to the reference depth data 1105 may be seen to the user as the size capable of performing the touch input. As the virtual object 605 is displayed according to the third depth data 1105 within the reference depth range, the user 501 may perform the touch input for the virtual object 605 without moving in the direction with respect to the virtual object 605.

According to an embodiment, the at least one processor 210 may refrain from (or cease, or bypass, or not enter) entering the touch input mode based on the second depth data 810 of the external object 805 smaller than the reference depth data 1105. The at least one processor 210 may display a pop-up window notifying that the touch input mode is not entered (or cannot be entered) in the virtual 3D space 505. In case of displaying the virtual object 605 in front of the external object 805 having the second depth data 810 smaller than the reference depth data 1105 in the virtual 3D space 505, the at least one processor 210 may maintain the display location of the virtual object 605 and refrain from (or cease, bypass, or not entering) entering the touch input mode.

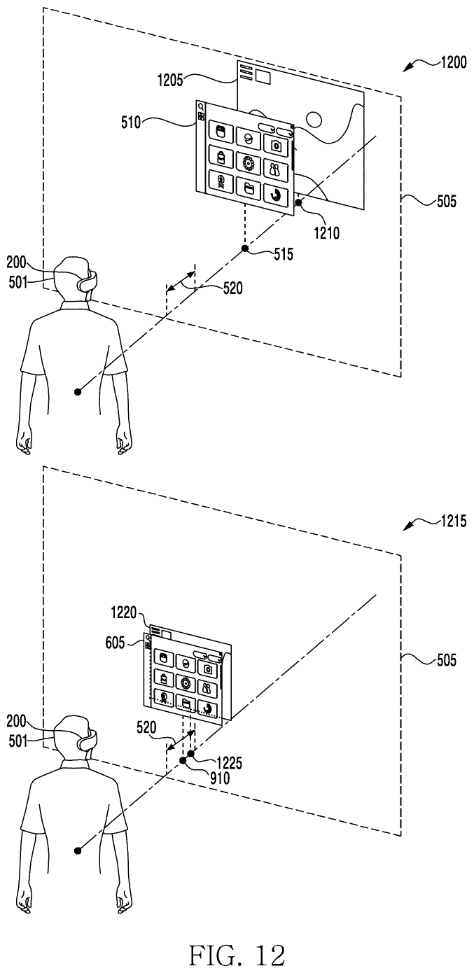

According to an embodiment, the at least one processor 210 may display a plurality of virtual objects in the virtual 3D space 505. The at least one processor 210 may adjust depth data of the plurality of virtual objects to receive a touch input for the plurality of virtual objects. Changing display locations of the plurality of virtual objects by adjusting the depth data of the plurality of virtual objects will be illustrated and described in greater detail below with reference to FIG. 12.

FIG. 12 is a diagram illustrating an example of changing display locations of a plurality of virtual objects according to various embodiments.

Referring to FIG. 12, according to an embodiment, a state 1200 may be described as a state before the display locations of the plurality of virtual objects (e.g., a virtual object 510 and another virtual object 1205) are changed. In the state 1200, at least one processor 210 may display the virtual object 510 and the other virtual object 1205 in a virtual 3D space 505. The at least one processor 210 may enter a touch input mode while the virtual object 510 and the other virtual object 1205 are displayed in the virtual 3D space 505.

According to an embodiment, the at least one processor 210 may identify first depth data 515 of the virtual object 510 and fifth depth data 1210 of the other virtual object 1205 based on entering the touch input mode. The at least one processor 210 may identify that the first depth data 515 and the fifth depth data 1210 are outside a reference depth range 520. Based on identifying that the first depth data 515 and the fifth depth data 1210 are outside the reference depth range 520, a head-wearable electronic device 200 may switch from the state 1200 to a state 1215.

According to an embodiment, the state 1215 may be described as a state in which display locations of a plurality of virtual objects (e.g., a virtual object 605 and a virtual object 1220) are changed. In the state 1215, based on identifying that the first depth data 515 and the fifth depth data 1210 are outside the reference depth range 520, the at least one processor 210 may adjust the first depth data 515 of the virtual object 510 to third depth data 910 within the reference depth range 520, and adjust the fifth depth data 1210 of the other virtual object 1205 to sixth depth data 1225 within the reference depth range 520. The at least one processor 210 may change a display location of the virtual object 510 by adjusting the first depth data 515 of the virtual object 510 to the third depth data 910. The at least one processor 210 may change a display location of the other virtual object 1205 by adjusting the fifth depth data 1210 of the other virtual object 1205 to the sixth depth data 1225. The at least one processor 210 may display the virtual object 510 and the other virtual object 1205 in a row in a front direction of a user, by changing the display locations of the virtual object 510 and the other virtual object 1205. By displaying the virtual object 510 and the other virtual object 1205 in a row in the front direction of the user, a field of view of the user may be relatively less obstructed, or a relatively wider space in the virtual 3D space 505 may be seen by the user.

According to an embodiment, the at least one processor 210 may adjust a first size of the virtual object 510 to a second size within a reference size range. The at least one processor 210 may adjust a third size of the other virtual object 1205 to a fourth size within the reference size range. An aspect ratio of the other virtual object 1205 having the third size may correspond to an aspect ratio of the other virtual object 1220 having the fourth size.

According to an embodiment, the at least one processor 210 may display the virtual object 605 having the second size according to the third depth data 910 in the virtual 3D space 505, and display the other virtual object 1220 having the fourth size according to the sixth depth data 1225. As the virtual object 605 displayed according to the third depth data 910 has the second size within the reference size range, the virtual object 605 may be seen to the user as a size in which the user may perform a touch input. As the other virtual object 1220 displayed according to the sixth depth data 1225 has the fourth size within the reference size range, the other virtual object 1220 may be seen to the user as the size in which the user may perform the touch input. At least a portion of the other virtual object 1220 may be seen by a user 501 by not overlapping the virtual object 605. The at least one processor 210 may recognize a hand of the user 501 contacted on the at least a portion of the other virtual object 1220 seen to the user 501 as a touch input for the other virtual object 1220.

According to an embodiment, the user 501 may perform a touch input for the virtual object 605 without moving (or without bending an arm) in a direction with respect to the virtual object 605, by displaying the virtual object 605 according to the third depth data 910 within the reference depth range 520. By displaying the other virtual object 1220 according to the sixth depth data 1225 within the reference depth range 520, the user 501 may perform the touch input for the other virtual object 1220 without moving (or without bending the arm) in a direction with respect to the other virtual object 1220. The at least one processor 210 may adjust the sixth depth data 1225 of the other virtual object 1220 to the third depth data 910 based on the touch input for the other virtual object 1220, and adjust the third depth data 910 of the virtual object 605 to the sixth depth data 1225. By adjusting the sixth depth data 1225 of the virtual object 1220 to the third depth data 910 and adjusting the third depth data 910 of the virtual object 605 to the sixth depth data 1225, the at least one processor 210 may change a display location of the virtual object 1220 to a display location of the virtual object 605 and change the display location of the virtual object 605 to the display location of the other virtual object 1220. The at least one processor 210 may display the other virtual object 1220 in front of the virtual object 605 by changing the display location of the other virtual object 1220 to the display location of the virtual object 605 and changing the display location of the virtual object 605 to the display location of the other virtual object 1220. The at least one processor 210 may provide a function mapped to the other virtual object 1220 based on receiving the touch input for the other virtual object 1220, by displaying the other virtual object 1220 in front of the virtual object 605 in the virtual 3D space 505.

According to an embodiment, the at least one processor 210 may further display an executable object next to the virtual object 605 in the virtual 3D space 505. Based on receiving a touch input for the executable object, the at least one processor 210 may change the display location of the virtual object 605 to the display location of the other virtual object 1220, and change the display location of the other virtual object 1220 to the display location of the virtual object 605. The at least one processor 210 may provide the function mapped to the other virtual object 1220, based on displaying the other virtual object 1220 in front of the virtual object 605 in the virtual 3D space 505 and receiving the touch input for the other virtual object 1220.

According to an embodiment, the at least one processor 210 may receive an input for selecting one virtual object from among the plurality of virtual objects 605 and 1220. Based on the input for selecting one virtual object from among the plurality of virtual objects 605 and 1220, the at least one processor 210 may display the selected virtual object in front of the user within the reference depth range and display remaining virtual objects excluding the selected virtual object behind the selected virtual object. According to an embodiment, as an external object is not located in the front direction of the user 501 in FIG. 12, changing the display location of the virtual object 605 and the display location of the other virtual object 1220 is illustrated, but the display location of the virtual object 605 and the display location of the other virtual object 1220 may be changed according to the second depth data of the external object illustrated and described with reference to FIG. 11.

According to an embodiment, the third depth data 910 of the virtual object 605 may be changed according to movement of the user 501 in the virtual 3D space 505. Adjusting depth data of the virtual object 605 changed according to the movement of the user 501, may be required.

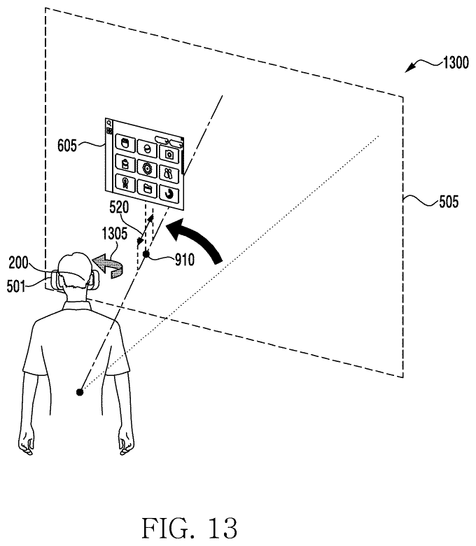

According to a change in a direction of a head of the user 501, the virtual object 605 may not be located in the front direction of the user 501 in the virtual 3D space 505. Maintaining the display location of the virtual object 605 changed according to the direction of the head of the user 501, may be required. Maintaining the display location of the virtual object 605 according to the movement of the user and the change in the direction of the head of the user will be illustrated and described in greater detail below with reference to FIG. 13.

FIG. 13 is a diagram illustrating an example of maintaining a display location of a virtual object according to movement of a user and a change in a direction of a head of the user according to various embodiments.

Referring to FIG. 13, according to an embodiment, a state 1300 may be described in a state in which a virtual object 605 is displayed according to third depth data 910 within a reference depth range 520 based on entering a touch input mode. In the state 1300, at least one processor 210 may identify movement of a user 501 and/or a change in a direction 1305 of a head of the user 501 while displaying the virtual object 605 according to the third depth data 910 in a virtual 3D space 505. While the virtual object 605 is displayed in the virtual 3D space 505, the third depth data 910 of the virtual object 605 may be changed as the user 501 moves. As the third depth data 910 of the virtual object 605 is changed, the user 501 may move in a direction with respect to the virtual object 605 or perform a touch input for the virtual object 605 by bending an arm. In order to address inconvenience of the user 501 according to a change of the third depth data 910 of the virtual object 605, the at least one processor 210 may adjust depth data of the virtual object 605 changed according to the movement of the user 501 to the third depth data 910. The at least one processor 210 may maintain the depth data of the virtual object 605 as the third depth data 910 even when the user 501 moves by adjusting the depth data of the virtual object 605 to the third depth data 910. The at least one processor 210 may maintain a display location of the virtual object 605 in the virtual 3D space 505 by maintaining the depth data of the virtual object 605 as the third depth data 910. As the at least one processor 210 maintains the display location of the virtual object 605 in the virtual 3D space 505, the user 501 may perform the touch input for the virtual object 605 without moving (or without bending the arm) in the direction with respect to the virtual object 605.

According to an embodiment, while the virtual object 605 is displayed in the virtual 3D space 505, as the direction 1305 of the head the user 501 is changed, the virtual object 605 may be displayed in another direction other than a front direction of the user 501. As the virtual object 605 is displayed in the other direction of the user 501, the user 501 may perform the touch input for the virtual object 605 by changing a gaze or rotating a body (or the head) in the direction with respect to the virtual object 605. In order to address the inconvenience of the user 501 due to the change in the display location of the virtual object 605, the at least one processor 210 may adjust the display location of the virtual object 605 in the virtual 3D space 505 changed according to the change in the direction 1305 of the head of the user 501, to the front direction of the user 501. By adjusting the display location of the virtual object 605 in the front direction of the user 501, the at least one processor 210 may maintain the display location of the virtual object 605 in the front direction of the user even though the user 501 changes the direction 1305 of the head. As the at least one processor 210 maintains the display location of the virtual object 605 in the virtual 3D space 505, the user 501 may perform the touch input for the virtual object 605 without changing the gaze in the direction with respect to the virtual object 605 or rotating the body (or the head).

According to an embodiment, as the external object is not located in the front direction of the user 501 in FIG. 12, changing the display location of the virtual object 605 is illustrated, but the display location of the virtual object 605 may be changed according to the second depth data of the external object illustrated and described with reference to FIG. 11. While the virtual object 605 is displayed according to the third depth data 910 within the reference depth range 520 in the virtual 3D space 505, in case that the external object is located according to the second depth data smaller than the third depth data 910 in the front direction of the user 501 according to the movement of the user 501, and/or the change in the direction of the head of the user 501, the at least one processor 210 may display the virtual object 605 according to the fourth depth data smaller than the second depth data. While displaying the virtual object 605 according to the fourth depth data smaller than the second depth data of the external object in the virtual 3D space 505, in case that the external object is not located in the front direction of the user 501 according to the movement of the user 501 and/or the change in the direction of the head of the user 501, the at least one processor 210 may display the virtual object 605 according to the third depth data 910 within the reference depth range 520.

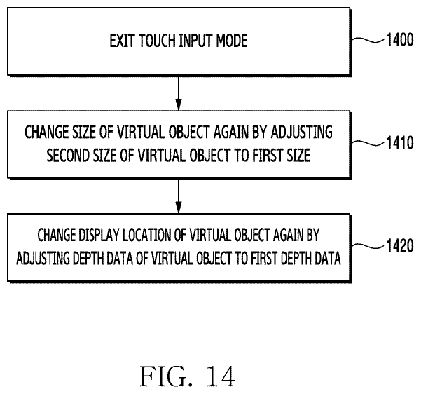

According to an embodiment, the at least one processor 210 may exit the touch input mode while displaying the virtual object 605 according to the third depth data 910 within the reference depth range 520 in the virtual 3D space 505, based on entering the touch input mode. The display location of the virtual object changed based on exiting the touch input mode will be illustrated and described in greater detail below with reference to FIG. 14.

FIG. 14 is a flowchart illustrating example operations of a head-wearable electronic device for changing a display location of a virtual object again according to various embodiments.

Referring to FIG. 14, according to an embodiment, in operation 1400, at least one processor 210 may exit a touch input mode while the display location of the virtual object is changed based on entering the touch input mode. The at least one processor 210 may exit the touch input mode based on an input of a user. As a non-limiting example, the user input for exiting the touch input mode may include an input for the virtual object (or a virtual button) in a virtual 3D space. The at least one processor 210 may exit the touch input mode by switching from the touch input mode to another input mode. In the other input mode, the at least one processor 210 may receive the input for the virtual object based on a user gesture (e.g., a pinch gesture) performed while a hand of the user is spaced apart from the virtual object.

According to an embodiment, the at least one processor 210 may exit the touch input mode for a portion of visual objects among a plurality of virtual objects displayed in the virtual 3D space. By exiting the touch input mode for the portion of virtual objects, the at least one processor 210 may receive the input for the portion of virtual objects based on the user gesture, and may receive a touch input for remaining virtual objects among the plurality of virtual objects.

According to an embodiment, in operation 1410, the at least one processor 210 may adjust a second size of the virtual object to a first size based on exiting the touch input mode. The at least one processor 210 may change a size of the virtual object again by adjusting the second size of the virtual object to the first size. In order to change the size of the virtual object again, the at least one processor 210 may store the first size of the virtual object in memory 220 before the size is changed, based on entering the touch input mode.

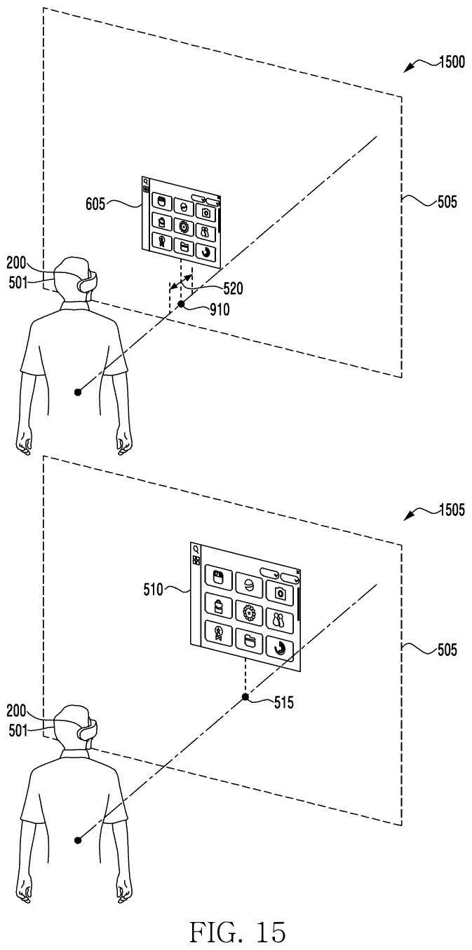

According to an embodiment, in operation 1420, the at least one processor 210 may change the display location of the virtual object again by adjusting third depth data of the virtual object to first depth data. In order to change the display location of the virtual object again, the at least one processor 210 may store the first depth data of the virtual object in the memory 220 before the display location is changed, based on entering the touch input mode. Changing the size and the display location of the virtual object again will be illustrated and described in greater detail below with reference to FIG. 15.

FIG. 15 is a diagram illustrating an example of changing a size and a display location of a virtual object again according to various embodiments.

Referring to FIG. 15, according to an embodiment, a state 1500 may be described as a state before a touch input mode is exited. In the state 1500, at least one processor 210 may display a virtual object 605 having a second size in a virtual 3D space 505 according to third depth data 910 within a reference depth range 520 while entering the touch input mode. Based on entering the touch input mode, the at least one processor 210 may store a first size before being changed to the second size of the virtual object 605 and first depth data (e.g., the first depth data 515 of FIG. 5) before being changed to the third depth data 910 of the virtual object 605 in memory 220. The at least one processor 210 may exit the touch input mode while displaying the virtual object 605 having the second size according to the third depth data 910 in the virtual 3D space 505. Based on exiting the touch input mode, a head-wearable electronic device 200 may switch from the state 1500 to a state 1505.

According to an embodiment, the state 1505 may be described as a state in which the touch input mode is exited. In the state 1505, the at least one processor 210 may change a size of a virtual object 510 by adjusting the second size of the virtual object 510 to the first size, based on exiting the touch input mode. The at least one processor 210 may change a display location of the virtual object 510 by adjusting the third depth data 910 of the virtual object 510 to the first depth data 515 based on exiting the touch input mode. The at least one processor 210 may call the first size and the first depth data 515 stored in the memory 220, based on exiting the touch input mode. According to an embodiment, the at least one processor 210 may display the virtual

object 510 having the first size in the virtual 3D space 505 according to the first depth data 515. Even though the virtual object 510 is displayed according to the first depth data 515, the at least one processor 210 may receive an input for the virtual object 510 based on a user gesture (e.g., a pinch gesture) performed while the hand of the user 510 is spaced apart from the virtual object 510 in another input mode.

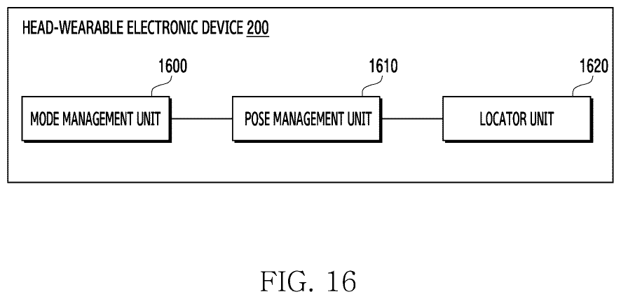

FIG. 16 is a block diagram illustrating an example configuration of a head-wearable electronic device according to various embodiments.

Referring to FIG. 16, a head-wearable electronic device 200 may include a mode management unit (e.g., including various circuitry and/or executable program instructions) 1600, a pose management unit (e.g., including various circuitry and/or executable program instructions) 1610, and/or a locator unit (e.g., including various circuitry and/or executable program instructions) 1620. The mode management unit 1600, the pose management unit 1610, and/or the locator unit 1620 may support a function of processing a virtual object through an algorithm stored in memory 220. The mode management unit 1600, the pose management unit 1610, and/or the locator unit 1620 are described as the term ‘unit’, but may perform the following functions in software and/or functionally.

According to an embodiment, the mode management unit 1600 may perform a function of managing a mode of applications running in the head-wearable electronic device 200. The mode management unit 1600 may display a screen capable of setting the mode through a display assembly 240. The mode management unit 1600 may enter a touch input mode while the virtual object provided from the application is displayed in a virtual 3D space. The mode management unit 1600 may store depth data of the virtual object and a size of the virtual object before a display location is changed, in the memory 220, based on entering the touch input mode. The mode management unit 1600 may call the depth data of the virtual object and the size of the virtual object stored in the memory 220, based on exiting the touch input mode.

According to an embodiment, the pose management unit 1610 may identify the depth data of the virtual object in order to change the display location of the virtual object. In order to change the display location of the virtual object, the pose management unit 1610 may identify whether the depth data of the virtual object is within a reference depth range. In order to display the virtual object in front of an external object, the pose management unit 1610 may identify depth data of the external object.

According to an embodiment, the locator unit 1620 may change the display location of the virtual object, based on entering the touch input mode. The locator unit 1620 may change the size of the virtual object based on entering the touch input mode.

FIG. 17 is a block diagram illustrating an electronic device 1701 in a network environment 1700 according to various embodiments.

Referring to FIG. 17, the electronic device 1701 in the network environment 1700 may communicate with an electronic device 1702 via a first network 1798 (e.g., a short-range wireless communication network), or at least one of an electronic device 1704 or a server 1708 via a second network 1799 (e.g., a long-range wireless communication network). According to an embodiment, the electronic device 1701 may communicate with the electronic device 1704 via the server 1708. According to an embodiment, the electronic device 1701 may include a processor 1720, memory 1730, an input module 1750, a sound output module 1755, a display module 1760, an audio module 1770, a sensor module 1776, an interface 1777, a connecting terminal 1778, a haptic module 1779, a camera module 1780, a power management module 1788, a battery 1789, a communication module 1790, a subscriber identification module (SIM) 1796, or an antenna module 1797. In some embodiments, at least one of the components (e.g., the connecting terminal 1778) may be omitted from the electronic device 1701, or one or more other components may be added in the electronic device 1701. In some embodiments, some of the components (e.g., the sensor module 1776, the camera module 1780, or the antenna module 1797) may be implemented as a single component (e.g., the display module 1760).

The processor 1720 may execute, for example, software (e.g., a program 1740) to control at least one other component (e.g., a hardware or software component) of the electronic device 1701 coupled with the processor 1720, and may perform various data processing or computation. According to an embodiment, as at least part of the data processing or computation, the processor 1720 may store a command or data received from another component (e.g., the sensor module 1776 or the communication module 1790) in volatile memory 1732, process the command or the data stored in the volatile memory 1732, and store resulting data in non-volatile memory 1734. According to an embodiment, the processor 1720 may include a main processor 1721 (e.g., a central processing unit (CPU) or an application processor (AP)), or an auxiliary processor 1723 (e.g., a graphics processing unit (GPU), a neural processing unit (NPU), an image signal processor (ISP), a sensor hub processor, or a communication processor (CP)) that is operable independently from, or in conjunction with, the main processor 1721. For example, when the electronic device 1701 includes the main processor 1721 and the auxiliary processor 1723, the auxiliary processor 1723 may be adapted to consume less power than the main processor 1721, or to be specific to a specified function. The auxiliary processor 1723 may be implemented as separate from, or as part of the main processor 1721. Thus, the processor 1720 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 1723 may control at least some of functions or states related to at least one component (e.g., the display module 1760, the sensor module 1776, or the communication module 1790) among the components of the electronic device 1701, instead of the main processor 1721 while the main processor 1721 is in an inactive (e.g., sleep) state, or together with the main processor 1721 while the main processor 1721 is in an active state (e.g., executing an application). According to an embodiment, the auxiliary processor 1723 (e.g., an image signal processor or a communication processor) may be implemented as part of another component (e.g., the camera module 1780 or the communication module 1790) functionally related to the auxiliary processor 1723. According to an embodiment, the auxiliary processor 1723 (e.g., the neural processing unit) may include a hardware structure specified for artificial intelligence model processing. An artificial intelligence model may be generated by machine learning. Such learning may be performed, e.g., by the electronic device 1701 where the artificial intelligence is performed or via a separate server (e.g., the server 1708). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1730 may store various data used by at least one component (e.g., the processor 1720 or the sensor module 1776) of the electronic device 1701. The various data may include, for example, software (e.g., the program 1740) and input data or output data for a command related thereto. The memory 1730 may include the volatile memory 1732 or the non-volatile memory 1734.

The program 1740 may be stored in the memory 1730 as software, and may include, for example, an operating system (OS) 1742, middleware 1744, or an application 1746.

The input module 1750 may receive a command or data to be used by another component (e.g., the processor 1720) of the electronic device 1701, from the outside (e.g., a user) of the electronic device 1701. The input module 1750 may include, for example, a microphone, a mouse, a keyboard, a key (e.g., a button), or a digital pen (e.g., a stylus pen).

The sound output module 1755 may output sound signals to the outside of the electronic device 1701. The sound output module 1755 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1760 may visually provide information to the outside (e.g., a user) of the electronic device 1701. The display module 1760 may include, for example, a display, a hologram device, or a projector and control circuitry to control a corresponding one of the display, hologram device, and projector. According to an embodiment, the display module 1760 may include a touch sensor adapted to detect a touch, or a pressure sensor adapted to measure the intensity of force incurred by the touch.

The audio module 1770 may convert a sound into an electrical signal and vice versa. According to an embodiment, the audio module 1770 may obtain the sound via the input module 1750, or output the sound via the sound output module 1755 or a headphone of an external electronic device (e.g., an electronic device 1702) directly (e.g., wiredly) or wirelessly coupled with the electronic device 1701.

The sensor module 1776 may detect an operational state (e.g., power or temperature) of the electronic device 1701 or an environmental state (e.g., a state of a user) external to the electronic device 1701, and then generate an electrical signal or data value corresponding to the detected state. According to an embodiment, the sensor module 1776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1777 may support one or more specified protocols to be used for the electronic device 1701 to be coupled with the external electronic device (e.g., the electronic device 1702) directly (e.g., wiredly) or wirelessly. According to an embodiment, the interface 1777 may include, for example, a high definition multimedia interface (HDMI), a universal serial bus (USB) interface, a secure digital (SD) card interface, or an audio interface.

A connecting terminal 1778 may include a connector via which the electronic device 1701 may be physically connected with the external electronic device (e.g., the electronic device 1702). According to an embodiment, the connecting terminal 1778 may include, for example, an HDMI connector, a USB connector, a SD card connector, or an audio connector (e.g., a headphone connector).

The haptic module 1779 may convert an electrical signal into a mechanical stimulus (e.g., a vibration or a movement) or electrical stimulus which may be recognized by a user via his tactile sensation or kinesthetic sensation. According to an embodiment, the haptic module 1779 may include, for example, a motor, a piezoelectric element, or an electric stimulator.

The camera module 1780 may capture a still image or moving images. According to an embodiment, the camera module 1780 may include one or more lenses, image sensors, image signal processors, or flashes.

The power management module 1788 may manage power supplied to the electronic device 1701. According to an embodiment, the power management module 1788 may be implemented as at least part of, for example, a power management integrated circuit (PMIC).

The battery 1789 may supply power to at least one component of the electronic device 1701. According to an embodiment, the battery 1789 may include, for example, a primary cell which is not rechargeable, a secondary cell which is rechargeable, or a fuel cell.

The communication module 1790 may support establishing a direct (e.g., wired) communication channel or a wireless communication channel between the electronic device 1701 and the external electronic device (e.g., the electronic device 1702, the electronic device 1704, or the server 1708) and performing communication via the established communication channel. The communication module 1790 may include one or more communication processors that are operable independently from the processor 1720 (e.g., the application processor (AP)) and supports a direct (e.g., wired) communication or a wireless communication. According to an embodiment, the communication module 1790 may include a wireless communication module 1792 (e.g., a cellular communication module, a short-range wireless communication module, or a global navigation satellite system (GNSS) communication module) or a wired communication module 1794 (e.g., a local area network (LAN) communication module or a power line communication (PLC) module). A corresponding one of these communication modules may communicate with the external electronic device via the first network 1798 (e.g., a short-range communication network, such as Bluetooth™, wireless-fidelity (Wi-Fi) direct, or infrared data association (IrDA)) or the second network 1799 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1792 may identify and authenticate the electronic device 1701 in a communication network, such as the first network 1798 or the second network 1799, using subscriber information (e.g., international mobile subscriber identity (IMSI)) stored in the subscriber identification module 1796.

The wireless communication module 1792 may support a 5G network, after a 4G network, and next-generation communication technology, e.g., new radio (NR) access technology. The NR access technology may support enhanced mobile broadband (cMBB), massive machine type communications (mMTC), or ultra-reliable and low-latency communications (URLLC). The wireless communication module 1792 may support a high-frequency band (e.g., the mm Wave band) to achieve, e.g., a high data transmission rate. The wireless communication module 1792 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1792 may support various requirements specified in the electronic device 1701, an external electronic device (e.g., the electronic device 1704), or a network system (e.g., the second network 1799). According to an embodiment, the wireless communication module 1792 may support a peak data rate (e.g., 20 Gbps or more) for implementing cMBB, loss coverage (e.g., 1764 dB or less) for implementing mMTC, or U-plane latency (e.g., 0.5 ms or less for each of downlink (DL) and uplink (UL), or a round trip of 17 ms or less) for implementing URLLC.

The antenna module 1797 may transmit or receive a signal or power to or from the outside (e.g., the external electronic device) of the electronic device 1701. According to an embodiment, the antenna module 1797 may include an antenna including a radiating element composed of a conductive material or a conductive pattern formed in or on a substrate (e.g., a printed circuit board (PCB)). According to an embodiment, the antenna module 1797 may include a plurality of antennas (e.g., array antennas). In such a case, at least one antenna appropriate for a communication scheme used in the communication network, such as the first network 1798 or the second network 1799, may be selected, for example, by the communication module 1790 (e.g., the wireless communication module 1792) from the plurality of antennas. The signal or the power may then be transmitted or received between the communication module 1790 and the external electronic device via the selected at least one antenna. According to an embodiment, another component (e.g., a radio frequency integrated circuit (RFIC)) other than the radiating element may be additionally formed as part of the antenna module 1797.

According to various embodiments, the antenna module 1797 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1701 and the external electronic device 1704 via the server 1708 coupled with the second network 1799. Each of the electronic devices 1702 or 1704 may be a device of a same type as, or a different type, from the electronic device 1701. According to an embodiment, all or some of operations to be executed at the electronic device 1701 may be executed at one or more of the external electronic devices 1702, 1704, or 1708. For example, if the electronic device 1701 should perform a function or a service automatically, or in response to a request from a user or another device, the electronic device 1701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1701. The electronic device 1701 may provide the outcome, with or without further processing of the outcome, as at least part of a reply to the request. To that end, a cloud computing, distributed computing, mobile edge computing (MEC), or client-server computing technology may be used, for example. The electronic device 1701 may provide ultra low-latency services using, e.g., distributed computing or mobile edge computing. In another embodiment, the external electronic device 1704 may include an internet-of-things (IoT) device. The server 1708 may be an intelligent server using machine learning and/or a neural network. According to an embodiment, the external electronic device 1704 or the server 1708 may be included in the second network 1799. The electronic device 1701 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1740) including one or more instructions that are stored in a storage medium (e.g., internal memory 1736 or external memory 1738) that is readable by a machine (e.g., the electronic device 1701). For example, a processor (e.g., the processor 1720) of the machine (e.g., the electronic device 1701) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The technical problem to be achieved in the present disclosure is not limited to the technical problem mentioned above, and other technical problems not mentioned will be clearly understood by those having ordinary knowledge in the art to which the present disclosure belongs.

As described above, according to an example embodiment, a head-wearable electronic device (e.g., the head-wearable electronic device 200 of FIG. 2) may comprise: at least one processor (e.g., the at least one processor 210 of FIG. 2) comprising processing circuitry, a display assembly (e.g., the display assembly 240 of FIG. 2) including a display, and memory (e.g., the memory 220 of FIG. 2), storing one or more programs configured to be executed by the at least one processor individually and/or collectively, and comprising one or more storage media. The one or more programs may include instructions to cause the head-wearable electronic device to: display a virtual object (e.g., the virtual object 510 of FIG. 5) in a three-dimensional (3D) space (e.g., the 3D space 505 of FIG. 5) provided through the display assembly. The one or more programs may include instructions to cause the head-wearable electronic device to, while displaying the virtual object in the 3D space, enter a touch input mode recognizing a hand of a user being contacted on a user interface (UI) object as a user input. The one or more programs may include instructions to cause the head-wearable electronic device to, based on entering the touch input mode, identify first depth data (e.g., the first depth data 515 of FIG. 5) of the virtual object. The one or more programs may include instructions to cause the head-wearable electronic device to, based on identifying that the first depth data of the virtual object is outside of a reference depth range (e.g., the reference depth range 520 of FIG. 5), change a display location of the virtual object by adjusting the first depth data of the virtual object to second depth data (e.g., the third depth data 910 of FIG. 9) within the reference depth range.

The one or more programs may include instructions to cause the head-wearable electronic device to, based on identifying that the first depth data of the virtual object is within the reference depth range, maintain the display location of the virtual object by maintaining the first depth data of the virtual object.

The one or more programs may include instructions to cause the head-wearable electronic device to, while displaying the virtual object in the 3D space in accordance with the second depth data, exit the touch input mode. The one or more programs may include instructions to cause the head-wearable electronic device to, based on exiting the touch input mode, change the display location of the virtual object again by adjusting the second depth data of the virtual object to the first depth data.

The one or more programs may include instructions to cause the head-wearable electronic device to, based on entering the touch input mode, identify a first size of the virtual object. The one or more programs may include instructions to cause the head-wearable electronic device to, based on identifying that the first depth data of the virtual object is outside of the reference depth range, display the virtual object having a second size in the 3D space in accordance with the second depth data by adjusting the first size of the virtual object to the second size within a reference size range.

The one or more programs may include instructions to cause the head-wearable electronic device to, based on entering the touch input mode, identify an aspect ratio of the virtual object. The one or more programs may include instructions to cause the head-wearable electronic device to, based on identifying that the first depth data of the virtual object is outside of the reference depth range, display the virtual object having the second size and the aspect ratio in the 3D space in accordance with the second depth data by adjusting the first size of the virtual object to the second size while maintaining the aspect ratio.

The one or more programs may include instructions to cause the head-wearable electronic device to, while displaying the virtual object having the second size in the 3D space in accordance with the second depth data, exit the touch input mode. The one or more programs may include instructions to cause the head-wearable electronic device to, based on exiting the touch input mode, display the virtual object having the first size in the 3D space in accordance with the first depth data again by adjusting the second depth data of the virtual object to the first depth data, and by adjusting the second size of the virtual object to the first size.

The head-wearable electronic device may further comprise one or more cameras. The one or more programs may include instructions to cause the head-wearable electronic device to identify, using the one or more cameras, third depth data of an external object. The one or more programs may include instructions to cause the head-wearable electronic device to, based on identifying that the first depth data of the virtual object is outside of the reference depth range, compare the third depth data of the external object with the reference depth range. The one or more programs may include instructions to cause the head-wearable electronic device to, based on the third depth data of the external object smaller than the reference depth range, change the display location of the virtual object by adjusting the first depth data of the virtual object to fourth depth data smaller than the third depth data.

The one or more programs may include instructions to cause the head-wearable electronic device to, based on the third depth data of the external object bigger than the reference depth range, change the display location of the virtual object by adjusting the first depth data of the virtual object to the second depth data.

The one or more programs may include instructions to cause the head-wearable electronic device to, based on the third depth data of the external object smaller than the reference depth range, compare the third depth data of the external object with reference depth data smaller than the second depth data. The one or more programs may include instructions to cause the head-wearable electronic device to, based on the third depth data of the external object smaller than the reference depth data, change the display location of the virtual object to be viewed by the user by moving the virtual object next to the external object, and by adjusting the first depth data of the virtual object to the second depth data.

The one or more programs may include instructions to cause the head-wearable electronic device to, while displaying the virtual object in accordance with the second depth data, maintain the second depth data of the virtual object by changing the display location of the virtual object in accordance with changing of a location of the user.

The one or more programs may include instructions to cause the head-wearable electronic device to identify a direction of a head of the user. The one or more programs may include instructions to cause the head-wearable electronic device to, while displaying the virtual object in accordance with the second depth data, change the display location of the virtual object in accordance with the identified direction to be located on a front direction of the user.

The one or more programs may include instructions to cause the head-wearable electronic device to, while displaying the virtual object and another virtual object in the 3D space, enter the touch input mode. The one or more programs may include instructions to cause the head-wearable electronic device to, based on entering the touch input mode, identify the first depth data of the virtual object and third depth data of the another virtual object. The one or more programs may include instructions to cause the head-wearable electronic device to, based on identifying that the first depth data of the virtual object and the third depth data of the another virtual object are outside of the reference depth range, change the display location of the virtual object by adjusting the first depth data of the virtual object to the second depth data, and change a display location of the another virtual object by adjusting the third depth data to fourth depth data within the reference depth range.

The head-wearable electronic device may further comprise one or more cameras. The one or more programs may include instructions to cause the head-wearable electronic device to identify, using the one or more cameras, that the hand of the user is contacted with the another virtual object. The one or more programs may include instructions to cause the head-wearable electronic device to, based on the identification, change the display location of the virtual object by adjusting the second depth data of the virtual object to the fourth depth data, and change the display location of the another virtual object by adjusting the fourth depth data of the another virtual object to the second depth data.

The head-wearable electronic device may further comprise one or more cameras. The one or more programs may include instructions to cause the head-wearable electronic device to, while displaying the virtual object in accordance with the second depth data, identify, using the one or more cameras, that the hand of the user is contacted with the virtual object. The one or more programs may include instructions to cause the head-wearable electronic device to, based on the identification, provide a function mapped to the virtual object.

The one or more programs may include instructions to cause the head-wearable electronic device to, based on the first depth data of the virtual object that is outside of the reference depth range identified while displaying another virtual object in accordance with the third depth data smaller than the second depth data, change the display location of the virtual object by adjusting the first depth data of the virtual object to the second depth data. The one or more programs may include instructions to cause the head-wearable electronic device to perform a blur processing to the another virtual object.

As described above, according to an example embodiment, a method may be executed in a head-wearable electronic device comprising a display assembly. The method may comprise:

displaying a virtual object in a three-dimensional (3D) space provided through the display assembly. The method may comprise, while displaying the virtual object in the 3D space, entering a touch input mode recognizing a hand of a user being contacted on a user interface (UI) object as a user input. The method may comprise, based on entering the touch input mode, identifying first depth data of the virtual object. The method may comprise, based on identifying that the first depth data of the virtual object is outside of a reference depth range, changing a display location of the virtual object by adjusting the first depth data of the virtual object to second depth data within the reference depth range.

The method may comprise, based on identifying that the first depth data of the virtual object is within the reference depth range, maintaining the display location of the virtual object by maintaining the first depth data of the virtual object.

The method may comprise, while displaying the virtual object in the 3D space in accordance with the second depth data, exiting the touch input mode. The method may comprise, based on exiting the touch input mode, changing the display location of the virtual object again by adjusting the second depth data of the virtual object to the first depth data.

The method may comprise, based on entering the touch input mode, identifying a first size of the virtual object. The method may comprise, based on identifying that the first depth data of the virtual object is outside of the reference depth range, displaying the virtual object having a second size in the 3D space in accordance with the second depth data by adjusting the first size of the virtual object to the second size within a reference size range.

The method may comprise, based on entering the touch input mode, identifying an aspect ratio of the virtual object. The method may comprise, based on identifying that the first depth data of the virtual object is outside of the reference depth range, displaying the virtual object having the second size and the aspect ratio in the 3D space in accordance with the second depth data by adjusting the first size of the virtual object to the second size while maintaining the aspect ratio.

The method may comprise, while displaying the virtual object having the second size in the 3D space in accordance with the second depth data, exiting the touch input mode. The method may comprise, based on exiting the touch input mode, displaying the virtual object having the first size in the 3D space in accordance with the first depth data again by adjusting the second depth data of the virtual object to the first depth data, and by adjusting the second size of the virtual object to the first size.

The head-wearable electronic device may further comprise one or more cameras. The method may comprise identifying, using the one or more cameras, third depth data of an external object. The method may comprise, based on identifying that the first depth data of the virtual object is outside of the reference depth range, comparing the third depth data of the external object with the reference depth range. The method may comprise, based on the third depth data of the external object smaller than the reference depth range, changing the display location of the virtual object by adjusting the first depth data of the virtual object to fourth depth data smaller than the third depth data.

The method may comprise, based on the third depth data of the external object bigger than the reference depth range, changing the display location of the virtual object by adjusting the first depth data of the virtual object to the second depth data.

The method may comprise, based on the third depth data of the external object smaller than the reference depth range, comparing the third depth data of the external object with reference depth data smaller than the second depth data. The method may comprise, based on the third depth data of the external object smaller than the reference depth data, changing the display location of the virtual object to be viewed by the user by moving the virtual object next to the external object, and by adjusting the first depth data of the virtual object to the second depth data.

The method may comprise, while displaying the virtual object in accordance with the second depth data, maintaining the second depth data of the virtual object by changing the display location of the virtual object changed in accordance with changing of a location of the user.

The method may comprise identifying a direction of a head of the user. The method may comprise, while displaying the virtual object in accordance with the second depth data, changing a display location of the virtual object changed in accordance with the identified direction to be located on a front direction of the user.

The method may comprise, while displaying the virtual object and another virtual object in the 3D space, entering the touch input mode. The method may comprise, based on entering the touch input mode, identifying the first depth data of the virtual object and third depth data of the another virtual object. The method may comprise, based on identifying that the first depth data of the virtual object and the third depth data of the another virtual object are outside of the reference depth range, changing the display location of the virtual object by adjusting the first depth data of the virtual object to the second depth data, and change a display location of the another virtual object by adjusting the third depth data to fourth depth data within the reference depth range.

The head-wearable electronic device may further comprise one or more cameras. The method may comprise identifying, using the one or more cameras, that the hand of the user is contacted with the another virtual object. The method may comprise, based on the identification, changing the display location of the virtual object by adjusting the second depth data of the virtual object to the fourth depth data, and change the display location of the another virtual object by adjusting the fourth depth data of the another virtual object to the second depth data.

The head-wearable electronic device may further comprise one or more cameras. The method may comprise, while displaying the virtual object in accordance with the second depth data, identifying, using the one or more cameras, that the hand of the user is contacted with the virtual object. The method may comprise, based on the identification, providing a function mapped to the virtual object.

The method may comprise, based on the first depth data of the virtual object that is outside of the reference depth range identified while displaying another virtual object in accordance with the third depth data smaller than the second depth data, changing the display location of the virtual object by adjusting the first depth data of the virtual object to the second depth data. The method may comprise performing a blur processing to the another virtual object.

As described above, a non-transitory computer-readable storage media may store one or more programs. The one or more programs may include, when executed by a head-wearable electronic device including a display assembly, instructions to cause the head-wearable electronic device to display a virtual object in a three-dimensional (3D) space provided through the display assembly. The one or more programs may include, when executed by the head-wearable electronic device, instructions to cause the head-wearable electronic device to, while displaying the virtual object in the 3D space, enter a touch input mode recognizing a hand of a user being contacted on a user interface (UI) object as a user input. The one or more programs may include, when executed by the head-wearable electronic device, instructions to cause the head-wearable electronic device to, based on entering the touch input mode, identify first depth data of the virtual object. The one or more programs may include, when executed by the head-wearable electronic device, instructions to cause the head-wearable electronic device to, based on identifying that the first depth data of the virtual object is outside of a reference depth range, change a display location of the virtual object by adjusting the first depth data of the virtual object to second depth data within the reference depth range.

The one or more programs may include, when executed by the head-wearable electronic device, instructions to cause the head-wearable electronic device to, based on identifying that the first depth data of the virtual object is within the reference depth range, maintain the display location of the virtual object by maintaining the first depth data of the virtual object.

The one or more programs may include, when executed by the head-wearable electronic device, instructions to cause the head-wearable electronic device to, while displaying the virtual object in the 3D space in accordance with the second depth data, exit the touch input mode. The one or more programs may include, when executed by the head-wearable electronic device, instructions to cause the head-wearable electronic device to, based on exiting the touch input mode, change the display location of the virtual object again by adjusting the second depth data of the virtual object to the first depth data.

The one or more programs may include, when executed by the head-wearable electronic device, instructions to cause the head-wearable electronic device to, based on entering the touch input mode, identify a first size of the virtual object. The one or more programs may include, when executed by the head-wearable electronic device, instructions to cause the head-wearable electronic device to, based on identifying that the first depth data of the virtual object is outside of the reference depth range, display the virtual object having a second size in the 3D space in accordance with the second depth data by adjusting the first size of the virtual object to the second size within a reference size range.

The one or more programs may include, when executed by the head-wearable electronic device, instructions to cause the head-wearable electronic device to, based on entering the touch input mode, identify an aspect ratio of the virtual object. The one or more programs may include,, when executed by the head-wearable electronic device, instructions to cause the head-wearable electronic device to, based on identifying that the first depth data of the virtual object is outside of the reference depth range, display the virtual object having the second size and the aspect ratio in the 3D space in accordance with the second depth data by adjusting the first size of the virtual object to the second size while maintaining the aspect ratio.

The one or more programs may include, when executed by the head-wearable electronic device, instructions to cause the head-wearable electronic device to, while displaying the virtual object having the second size in the 3D space in accordance with the second depth data, exit the touch input mode. The one or more programs may include, when executed by the head-wearable electronic device, instructions to cause the head-wearable electronic device to, based on exiting the touch input mode, display the virtual object having the first size in the 3D space in accordance with the first depth data again by adjusting the second depth data of the virtual object to the first depth data, and by adjusting the second size of the virtual object to the first size.

The head-wearable electronic device may further comprise one or more cameras. The one or more programs may include, when executed by the head-wearable electronic device, instructions to cause the head-wearable electronic device to identify, using the one or more cameras, third depth data of an external object. The one or more programs may include, when executed by the head-wearable electronic device, instructions to cause the head-wearable electronic device to, based on identifying that the first depth data of the virtual object is outside of the reference depth range, compare the third depth data of the external object with the reference depth range. The one or more programs may include, when executed by the head-wearable electronic device, instructions to cause the head-wearable electronic device to, based on the third depth data of the external object smaller than the reference depth range, change the display location of the virtual object by adjusting the first depth data of the virtual object to fourth depth data smaller than the third depth data.

The one or more programs may include, when executed by the head-wearable electronic device, instructions to cause the head-wearable electronic device to, based on the third depth data of the external object bigger than the reference depth range, change the display location of the virtual object by adjusting the first depth data of the virtual object to the second depth data.

The one or more programs may include, when executed by the head-wearable electronic device, instructions to cause the head-wearable electronic device to, based on the third depth data of the external object smaller than the reference depth range, compare the third depth data of the external object with reference depth data smaller than the second depth data. The one or more programs may include, when executed by the head-wearable electronic device, instructions to cause the head-wearable electronic device to, based on the third depth data of the external object smaller than the reference depth data, change the display location of the virtual object to be viewed by the user by moving the virtual object next to the external object, and by adjusting the first depth data of the virtual object to the second depth data.

The one or more programs may include, when executed by the head-wearable electronic device, instructions to cause the head-wearable electronic device to, while displaying the virtual object in accordance with the second depth data, maintain the second depth data of the virtual object by changing the display location of the virtual object changed in accordance with changing of a location of the user.

The one or more programs may include, when executed by the head-wearable electronic device, instructions to cause the head-wearable electronic device to identify a direction of a head of the user. The one or more programs may include, when executed by the head-wearable electronic device, instructions to cause the head-wearable electronic device to, while displaying the virtual object in accordance with the second depth data, change the display location of the virtual object changed in accordance with the identified direction to be located on a front direction of the user.

The one or more programs may include, when executed by the head-wearable electronic device, instructions to cause the head-wearable electronic device to, while displaying the virtual object and another virtual object in the 3D space, enter the touch input mode. The one or more programs may include, when executed by the head-wearable electronic device, instructions to cause the head-wearable electronic device to, based on entering the touch input mode, identify the first depth data of the virtual object and third depth data of the another virtual object. The one or more programs may include, when executed by the head-wearable electronic device, instructions to cause the head-wearable electronic device to, based on identifying that the first depth data of the virtual object and the third depth data of the another virtual object are outside of the reference depth range, change the display location of the virtual object by adjusting the first depth data of the virtual object to the second depth data, and change a display location of the another virtual object by adjusting the third depth data to fourth depth data within the reference depth range.

The head-wearable electronic device may further comprise one or more cameras. The one or more programs may include, when executed by the head-wearable electronic device, instructions to cause the head-wearable electronic device to identify, using the one or more cameras, that the hand of the user is contacted with the another virtual object. The one or more programs may include, when executed by the head-wearable electronic device, instructions to cause the head-wearable electronic device to, based on the identification, change the display location of the virtual object by adjusting the second depth data of the virtual object to the fourth depth data, and change the display location of the another virtual object by adjusting the fourth depth data of the another virtual object to the second depth data.

The head-wearable electronic device may further comprise one or more cameras. The one or more programs may include, when executed by the head-wearable electronic device, instructions to cause the head-wearable electronic device to, while displaying the virtual object in accordance with the second depth data, identify, using the one or more cameras, that the hand of the user is contacted with the virtual object. The one or more programs may include, when executed by the head-wearable electronic device, instructions to cause the head-wearable electronic device to, based on the identification, provide a function mapped to the virtual object.

The one or more programs may include,, when executed by the head-wearable electronic device, instructions to cause the head-wearable electronic device to, based on the first depth data of the virtual object that is outside of the reference depth range identified while displaying another virtual object in accordance with the third depth data smaller than the second depth data, change the display location of the virtual object by adjusting the first depth data of the virtual object to the second depth data. The one or more programs may include, when executed by the head-wearable electronic device, instructions to cause the head-wearable electronic device to perform a blur processing to the another virtual object.

The effects that can be obtained from the present disclosure are not limited to those described above, and any other effects not mentioned herein will be clearly understood by one of ordinary skill in the art to which the present disclosure belongs.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A head-wearable electronic device comprising:
at least one processor comprising processing circuitry;
a display assembly including a display; and
memory, storing one or more programs configured to be executed by the at least one processor individually and/or collectively, comprising one or more storage media,
wherein the one or more programs include instructions to cause the head-wearable electronic device to:
display a virtual object in a three-dimensional (3D) space provided through the display assembly,
while displaying the virtual object in the 3D space, enter a touch input mode recognizing a hand of a user being contacted on a user interface (UI) object as a user input;
based on entering the touch input mode, identify first depth data of the virtual object; and
based on identifying that the first depth data of the virtual object is outside of a reference depth range, change a display location of the virtual object by adjusting the first depth data of the virtual object to second depth data within the reference depth range.

2. The head-wearable electronic device of claim 1,
wherein the one or more programs include instructions to cause the head-wearable electronic device to:
based on identifying that the first depth data of the virtual object is within the reference depth range, maintain the display location of the virtual object by maintaining the first depth data of the virtual object.

3. The head-wearable electronic device of claim 1,
wherein the one or more programs include instructions to cause the head-wearable electronic device to:
while displaying the virtual object in the 3D space in accordance with the second depth data, exit the touch input mode, and
based on exiting the touch input mode, change the display location of the virtual object again by adjusting the second depth data of the virtual object to the first depth data.

4. The head-wearable electronic device of claim 1,
wherein the one or more programs include instructions to cause the head-wearable electronic device to:
based on entering the touch input mode, identify a first size of the virtual object, and
based on identifying that the first depth data of the virtual object is outside of the reference depth range, display the virtual object having a second size in the 3D space in accordance with the second depth data by adjusting the first size of the virtual object to the second size within a reference size range.

5. The head-wearable electronic device of claim 4,
wherein the one or more programs include instructions to cause the head-wearable electronic device to:
based on entering the touch input mode, identify an aspect ratio of the virtual object, and
based on identifying that the first depth data of the virtual object is outside of the reference depth range, display the virtual object having the second size and the aspect ratio in the 3D space in accordance with the second depth data by adjusting the first size of the virtual object to the second size while maintaining the aspect ratio.

6. The head-wearable electronic device of claim 4,
wherein the one or more programs include instructions to cause the head-wearable electronic device to:
while displaying the virtual object having the second size in the 3D space in accordance with the second depth data, exit the touch input mode, and
based on exiting the touch input mode, display the virtual object having the first size in the 3D space in accordance with the first depth data again by adjusting the second depth data of the virtual object to the first depth data, and by adjusting the second size of the virtual object to the first size.

7. The head-wearable electronic device of claim 1,
further comprising one or more cameras,
wherein the one or more programs include instructions to cause the head-wearable electronic device to:
identify, using the one or more cameras, third depth data of an external object, based on identifying that the first depth data of the virtual object is outside of the reference depth range, compare the third depth data of the external object with the reference depth range, and
based on the third depth data of the external object being smaller than the reference depth range, change the display location of the virtual object by adjusting the first depth data of the virtual object to fourth depth data smaller than the third depth data.

8. The head-wearable electronic device of claim 7,
wherein the one or more programs include instructions to cause the head-wearable electronic device to:
based on the third depth data of the external object being bigger than the reference depth range, change the display location of the virtual object by adjusting the first depth data of the virtual object to the second depth data.

9. The head-wearable electronic device of claim 7,
wherein the one or more programs include instructions to cause the head-wearable electronic device to:
based on the third depth data of the external object being smaller than the reference depth range, compare the third depth data of the external object with reference depth data smaller than the second depth data, and
based on the third depth data of the external object being smaller than the reference depth data, change the display location of the virtual object to be viewed by the user by moving the virtual object next to the external object, and by adjusting the first depth data of the virtual object to the second depth data.

10. The head-wearable electronic device of claim 1,
wherein the one or more programs include instructions to cause the head-wearable electronic device to:
while displaying the virtual object in accordance with the second depth data, maintain the second depth data of the virtual object by changing the display location of the virtual object in accordance with changing of a location of the user.

11. The head-wearable electronic device of claim 1,
wherein the one or more programs include instructions to cause the head-wearable electronic device to:
identify a direction of a head of the user, and
while displaying the virtual object in accordance with the second depth data, change the display location of the virtual object in accordance with the identified direction to be located in a front direction of the user.

12. The head-wearable electronic device of claim 1,
wherein the one or more programs include instructions to cause the head-wearable electronic device to:
while displaying the virtual object and another virtual object in the 3D space, enter the touch input mode,
based on entering the touch input mode, identify the first depth data of the virtual object and third depth data of the another virtual object, and
based on identifying that the first depth data of the virtual object and the third depth data of the another virtual object are outside of the reference depth range, change the display location of the virtual object by adjusting the first depth data of the virtual object to the second depth data, and change a display location of the another virtual object by adjusting the third depth data to fourth depth data within the reference depth range.

13. The head-wearable electronic device of claim 12,
further comprising one or more cameras,
wherein the one or more programs include instructions to cause the head-wearable electronic device to:
identify, using the one or more cameras, that the hand of the user is contacted with the another virtual object, and
based on the identification, change the display location of the virtual object by adjusting the second depth data of the virtual object to the fourth depth data, and change the display location of the another virtual object by adjusting the fourth depth data of the another virtual object to the second depth data.

14. The head-wearable electronic device of claim 1,
further comprising one or more cameras,
wherein the one or more programs include instructions to cause the head-wearable electronic device to:
while displaying the virtual object in accordance with the second depth data, identify, using the one or more cameras, that the hand of the user is contacted with the virtual object, and
based on the identification, provide a function mapped to the virtual object.

15. The head-wearable electronic device of claim 1,
wherein the one or more programs include instructions to cause the head-wearable electronic device to:
based on the first depth data of the virtual object outside of the reference depth range identified while displaying another virtual object in accordance with third depth data smaller than the second depth data, change the display location of the virtual object by adjusting the first depth data of the virtual object to the second depth data, and perform a blur processing to the another virtual object.

16. A method executed in a head-wearable electronic device comprising a display assembly including a display, the method comprising:
displaying a virtual object in a three-dimensional (3D) space provided through the display assembly,
while displaying the virtual object in the 3D space, entering a touch input mode recognizing a hand of a user being contacted on a user interface (UI) object as a user input;
based on entering the touch input mode, identifying first depth data of the virtual object; and
based on identifying that the first depth data of the virtual object is outside of a reference depth range, changing a display location of the virtual object by adjusting the first depth data of the virtual object to second depth data within the reference depth range.

17. The method of claim 16, the method further comprising:
based on identifying that the first depth data of the virtual object is within the reference depth range, maintaining the display location of the virtual object by maintaining the first depth data of the virtual object.

18. The method of claim 16, the method further comprising:
while displaying the virtual object in the 3D space in accordance with the second depth data, exiting the touch input mode, and
based on exiting the touch input mode, changing the display location of the virtual object again by adjusting the second depth data of the virtual object to the first depth data.

19. The method of claim 16, the method further comprising:
based on entering the touch input mode, identifying a first size of the virtual object, and
based on identifying that the first depth data of the virtual object is outside of the reference depth range, displaying the virtual object having a second size in the 3D space in accordance with the second depth data by adjusting the first size of the virtual object to the second size within a reference size range.

20. The method of claim 19, the method further comprising:
based on entering the touch input mode, identifying an aspect ratio of the virtual object, and
based on identifying that the first depth data of the virtual object is outside of the reference depth range, displaying the virtual object having the second size and the aspect ratio in the 3D space in accordance with the second depth data by adjusting the first size of the virtual object to the second size while maintaining the aspect ratio.
